(19) United States
(12) Patent Application Publication
(10) Pub. No.: US 2025/0168626 A1
(43) Pub. Date: May 22, 2025

(54) Communication Security At A Physical Layer

(71) Applicant: QUALCOMM Incorporated, San Diego, CA (US)

(72) Inventors: Danlu ZHANG, San Diego, CA (US); Wei XI, Beijing (CN); Yu ZHANG, San Diego, CA (US); Chao WEI, Beijing (CN); Min HUANG, Beijing (CN); Hao XU, Beijing (CN); Giridhar Dhati MANDYAM, San Diego, CA (US); Patrick HUGHES, Carlsbad, CA (US)

(21) Appl. No.: 18/835,161

(22) PCT Filed: May 7, 2022
(86) PCT No.: PCT/CN2022/091357

§ 371 Date: Aug. 1, 2024

(51) Int. Cl. H04W 12/037; H04B 7/04; H04B 7/0413

(52) U.S. Cl. CPC H04W 12/037; H04B 7/04026; H04B 7/0413

(57) ABSTRACT

Various embodiments may provide communication security at a physical layer. In some embodiments, a first wireless device at a first location may transmit to a second wireless device at a second location different portions of a message via two or more different spatially separated signal paths in a manner that enables the second wireless device to receive the complete message but prevents reception of the complete message by a third wireless device at a third location different from the second location. The second wireless device may receive different portions of the message via the two or more different spatially separated signal paths, may assemble the message from the received different portions of the message.

### RELATED APPLICATIONS

This application is a U.S. National Phase application and claims priority to PCT Application PCT/CN2022/091357 entitled “Communication Security At A Physical Layer” filed May 7, 2022, the entire contents of which are incorporated herein for all purposes.

### BACKGROUD

In Long Term Evolution (LTE) Fifth Generation (5G) New Radio (NR) and other communication technologies, wireless devices may utilize millimeter wave (mmWave) frequency bands to provide high bandwidth communication links. As the use of such wireless communication technologies increases and evolves, communication security becomes increasingly important.

### SUMMARY

Various aspects include methods performed by a processor of a wireless device at a first location (a transmitting wireless device) for providing communication security at the physical layer in messages sent to a second wireless device at a second location (a receiving wireless device) remote from the first location. Various aspects may include dividing a message to be sent to the second wireless device into different portions, and transmitting the different portions of the message to the second wireless device via two or more different spatially separated signal paths in a manner that enables the second wireless device to receive the complete message but prevents reception of the complete message by a third wireless device at a third location different from the second location.

In some aspects, dividing the message to be sent to the second wireless device into different portions may include dividing the message before channel coding into different groups of packets, and transmitting the different portions of the message to the second wireless device via two or more different spatially separated signal paths may include transmitting the different groups of packets of the message via respective ones of a plurality of multiple input multiple output (MIMO) beams. Such aspects may include retransmitting one of the different packets of the message via the same MIMO beam as the originally-sent one of the different packets of the message.

In some aspects, transmitting different packets of the message via respective ones of a plurality of MIMO beam may include transmitting a first subset of packets of the message via a first MIMO beam directed toward the second wireless device, transmitting a second subset of packets of the message via a second MIMO beam toward a reconfigurable intelligent surface (RIS), and controlling the RIS to transmit the second subset of packets towards the second wireless device through signal reflection.

Some aspects may include encrypting the message prior to transmitting the different portions of the message via the two or more different spatially separated signal paths. Some aspects may include determining signal qualities of wireless signals transmitted over the two or more different spatially separated signal paths, and allocating the different portions of the message for transmitting via the two or more different spatially separated signal paths based on the determined signal qualities of the two or more different spatially separated signal paths.

In some aspects, dividing the message to be sent to the second wireless device into different portions may include dividing the message after a channel coding operation into coded bits of the message, mapping the coded bits to different modulation points of a modulation scheme, and transmitting the different portions of the message to the second wireless device via two or more different spatially separated signal paths may include transmitting the coded bits of the message mapped to different modulation points via different beams in which each of the different beams transmits a corresponding one of the different modulation points.

In some aspects, mapping the coded bits to different modulation points of a modulation scheme may include aggregating modulation positions of a component constellation across a plurality of symbols to determine a constellation aggregation, and partitioning the constellation aggregation into a plurality of subsets of symbols in which each subset corresponds to a different beam. In such aspects, transmitting coded bits of the message mapped to different modulation points via different beams in which each of the different beams transmits a corresponding one of the different modulation points may include transmitting each of the subsets of symbols via a corresponding beam. In some aspects, transmitting each of the subsets of symbols via a corresponding beam may include transmitting each of the subsets of symbols via holographic multiple input multiple output (H-MIMO) beams corresponding to the subsets of symbols.

Further aspects include a wireless device having a processor configured to perform one or more operations of any of the methods summarized above. Further aspects include processing devices for use in a wireless device configured with processor-executable instructions to perform operations of any of the methods summarized above. Further aspects include a non-transitory processor-readable storage medium having stored thereon processor-executable instructions configured to cause a processor of a wireless device to perform operations of any of the methods summarized above. Further aspects include a wireless device having means for performing functions of any of the methods summarized above. Further aspects include a system on chip for use in a wireless device and that includes a processor configured to perform one or more operations of any of the methods summarized above.

Various aspects include methods performed by a processor of a wireless device at a first location (a receiving wireless device) for providing communication security at a physical layer in messages received from a second wireless device at a second location (a transmitting wireless device) remote from the first location. Various aspects may include receiving different portions of a message sent from the second wireless device via two or more different spatially separated signal paths in a manner that enables the first wireless device to receive the complete message but prevents reception of the complete message by a third wireless device at a third location different from the first location, and assembling the message from the received different portions of the message.

In some aspects, receiving different portions of the message sent from the second wireless device via two or more different spatially separated signal paths may include receiving different groups of packets of the message via respective ones of two to more multiple input multiple output (MIMO) beams. Some aspects may include transmitting a request for retransmission of one of the packets of the message, and receiving retransmission of the one of the packets of the message via the same MIMO beam as the originally-sent one of the packets. In some aspects, receiving different portions of the message sent from the second wireless device via two or more different spatially separated signal paths may include receiving a first subset of packets of the message via a first MIMO beam from the second wireless device, and receiving a second subset of packets of the message via a second MIMO beam from a reconfigurable intelligent surface (RIS).

In some aspects, receiving different portions of the message sent from the second wireless device via two or more different spatially separated signal paths may include receiving different portions of the encrypted message sent from the second wireless device via two or more different spatially separated signal paths, and assembling the message using the received different portions of the message may include combining the different portions to assemble the message and decrypting the assembled message. In some aspects, receiving different portions of the message sent from the second wireless device via two or more different spatially separated signal paths may include receiving coded bits of the message via two or more different beams in which each beam corresponds to different modulation points of a modulation scheme. In some aspects, receiving coded bits of the message via two or more different beams in which each beam corresponds to different modulation points of a modulation scheme may include receiving subsets of symbols via holographic multiple input multiple output (H-MIMO) beams carrying the subsets of symbols.

Further aspects include a wireless device having a processor configured to perform one or more operations of any of the methods summarized above. Further aspects include processing devices for use in a wireless device configured with processor-executable instructions to perform operations of any of the methods summarized above. Further aspects include a non-transitory processor-readable storage medium having stored thereon processor-executable instructions configured to cause a processor of a wireless device to perform operations of any of the methods summarized above. Further aspects include a wireless device having means for performing functions of any of the methods summarized above. Further aspects include a system on chip for use in a wireless device and that includes a processor configured to perform one or more operations of any of the methods summarized above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the various embodiments.

FIG. 1A is a system block diagram illustrating an example communications system suitable for implementing any of the various embodiments.

FIG. 1B is a system block diagram illustrating an example disaggregated base station architecture suitable for implementing any of the various embodiments.

FIG. 2 is a component block diagram illustrating an example computing and wireless modem system suitable for implementing any of the various embodiments.

FIG. 3 is a component block diagram illustrating a software architecture including a radio protocol stack for the user and control planes in wireless communications suitable for implementing any of the various embodiments.

FIG. 4A is a block diagram of a reconfigurable intelligent surface (RIS) suitable for implementing any of the various embodiments.

FIGS. 4B and 4C illustrate aspects of an incident RF wave reflected from a portion of a RIS reflecting surface including two elements each including an antenna portion and a phase-shifter circuit element suitable for implementing any of the various embodiments

FIG. 5 is a system conceptual diagram illustrating example operations for providing communication security at a physical layer in a wireless communication system according to various embodiments.

FIG. 6 is a process flow diagram illustrating a method for providing communication security at a physical layer that may be performed by a processor of a wireless device according to various embodiments.

FIGS. 7A-7E are process flow diagrams illustrating operations that may be performed as part of the method for providing communication security at a physical layer that may be performed by a processor of a wireless device according to various embodiments.

FIG. 7F is a conceptual diagram illustrating an example aggregate constellation according to various embodiments.

FIG. 7G is a conceptual diagram illustrating example index modulation schemes for holographic multiple input multiple output (H-MIMO) according to various embodiments.

FIG. 8 is a process flow diagram illustrating a method for providing communication security at a physical layer that may be performed by a processor of a wireless device according to various embodiments.

FIGS. 9A-9C are process flow diagrams illustrating operations that may be performed as part of the method for providing communication security at a physical layer that may be performed by a processor of a wireless device according to various embodiments.

FIG. 10 is a component block diagram of a wireless device suitable for use with various embodiments.

FIG. 11 is a component block diagram of a wireless device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

MIMO schemes can concentrate energy into separate beams distributed in space (i.e., following different paths from the transmitter to the receiving wireless device), thereby transmitting wireless signals via physically separated paths. Various embodiments provide communication security at the physical layer by transmitting portions of a message along two or more different spatially separated signal paths. An eavesdropping wireless device attempting to intercept the message may be unable to receive all of the portions of the message because of the spatial separate of the various signal paths. In some embodiments, MIMO transmission methods may be used to provide physical layer security by dividing portions of information (e.g., a number of bits) before channel coding into separate groups that are transmitted over a separate MIMO branches. The grouping information may be made depending on the channel quality of each MIMO branch. HARQ retransmissions of data on each MIMO branch may be restricted to the same branch as a first transmission. In some embodiments, before coded bits are transmitted over all MIMO branches according to certain modulation, the coded bits may be divided into groups of coded bits each of which are transmitted over a subset of separate MIMO branches and on a specific subset of the modulation constellation. The grouping of coded bits may be made depending on the channel quality of each MIMO branch. In such embodiments, retransmission of groups of bits may not be needed.

The terms “wireless device” is used herein to refer to any one or all of user devices or user equipment (UE), base stations (including macro, micro, femto, and pico base stations), wireless router devices, wireless appliances, cellular telephones, smartphones, portable computing devices, personal or mobile multi-media players, laptop computers, tablet computers, smartbooks, ultrabooks, palmtop computers, wireless electronic mail receivers, multimedia Internet-enabled cellular telephones, medical devices and equipment, biometric sensors/devices, wearable devices including smart watches, smart clothing, smart glasses, smart wrist bands, smart jewelry (for example, smart rings and smart bracelets), entertainment devices (for example, wireless gaming controllers, music and video players, satellite radios, etc.), wireless-network enabled Internet of Things (IoT) devices including smart meters/sensors, industrial manufacturing equipment, large and small machinery and appliances for home or enterprise use, wireless communication elements within autonomous and semiautonomous vehicles, wireless devices affixed to or incorporated into various mobile platforms, global positioning system devices, and similar electronic devices that include a memory, wireless communication components and a programmable processor.

The term “system on chip” (SOC) is used herein to refer to a single integrated circuit (IC) chip that contains multiple resources or processors integrated on a single substrate. A single SOC may contain circuitry for digital, analog, mixed-signal, and radio-frequency functions. A single SOC also may include any number of general purpose or specialized processors (digital signal processors, modem processors, video processors, etc.), memory blocks (such as ROM, RAM, Flash, etc.), and resources (such as timers, voltage regulators, oscillators, etc.). SOCs also may include software for controlling the integrated resources and processors, as well as for controlling peripheral devices.

The term “system in a package” (SIP) may be used herein to refer to a single module or package that contains multiple resources, computational units, cores or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP also may include multiple independent SOCs coupled together via high speed communication circuitry and packaged in close proximity, such as on a single motherboard or in a single wireless device. The proximity of the SOCs facilitates high speed communications and the sharing of memory and resources.

As used herein, the terms “network,” “system,” “wireless network,” “cellular network,” and “wireless communication network” may interchangeably refer to a portion or all of a wireless network of a carrier associated with a wireless device and/or subscription on a wireless device. The techniques described herein may be used for various wireless communication networks, such as Code Division Multiple Access (CDMA), time division multiple access (TDMA), FDMA, orthogonal FDMA (OFDMA), single carrier FDMA (SC-FDMA) and other networks. In general, any number of wireless networks may be deployed in a given geographic area. Each wireless network may support at least one radio access technology, which may operate on one or more frequency or range of frequencies. For example, a CDMA network may implement Universal Terrestrial Radio Access (UTRA) (including Wideband Code Division Multiple Access (WCDMA) standards), CDMA2000 (including IS-2000, IS-95 and/or IS-856 standards), etc. In another example, a TDMA network may implement GSM Enhanced Data rates for GSM Evolution (EDGE). In another example, an OFDMA network may implement Evolved UTRA (E-UTRA) (including Long Term Evolution (LTE) standards), Institute of Electrical and Electronics Engineers (IEEE) 802.11 (Wi-Fi), IEEE 802.16 (WiMAX), IEEE 802.20, Flash-OFDM®, etc. Reference may be made to wireless networks that use LTE standards, and therefore the terms “Evolved Universal Terrestrial Radio Access,” “E-UTRAN” and “eNodeB” may also be used interchangeably herein to refer to a wireless network. However, such references are provided merely as examples, and are not intended to exclude wireless networks that use other communication standards. For example, while various Third Generation (3G) systems, Fourth Generation (4G) systems, and Fifth Generation (5G) systems are discussed herein, those systems are referenced merely as examples and future generation systems (e.g., sixth generation (6G) or higher systems) may be substituted in the various examples.

As used herein, “beam” refers to a signal formed at a transmitting device through the use of a beamforming or beam steering technique applied via a combination of physical equipment and signal processing variously referred to as a beamforming function, a mapping function, or a spatial filter. Beam reception by a receiving device may involve configuring physical equipment and signal processing of the receiving device to receive signals transmitted in a beam by the transmitting device. In some situations, beam reception by a receiving device also may involve configuring physical equipment and signal processing of the receiving device via a beamforming function, a mapping function, or a spatial filter so as to preferentially receive signals (e.g., with enhanced gain) from a particular direction (e.g., in a direction aligned with a transmitting device).

The term “beamforming” is used herein to refer to antenna array design and signal processing techniques used for directional signal communications and/or to achieve spatial selectivity (i.e., spatial filtering) of radio frequency (RF) signal reception. Beamforming on the transmitter end of communications may be accomplished by selective delaying (known as “phase shifting”) of signals coupled to different elements in an antenna array so that RF signals emitted by the antenna array at a particular angle (relative to the antenna array) are enhanced through constructive interference while RF signals emitted by the antenna array at other angles (relative to the antenna) exhibit lower signal strength due to destructive interference. Beamforming on the receiver end of communications may be accomplished by processing signals received by elements in an antenna array through phase shifting circuits so that RF signals received at particular angles relative to the receiving antenna array are enhanced through constructive interference while RF signals received at other angles relative to the wireless device are reduced in perceived signal strength through destructive interference. Using beamforming techniques, RF signals may be transmitted (e.g., by a base station or wireless device) in one or more directional “beams” within the millimeter band for ultra-wideband communications. Each of such directional beams may be controlled by the transmitter using beamforming techniques to sweep in one or two dimensions (i.e., azimuth and elevation directions). Beamforming in both transmitters and receivers may be accomplished using analog (e.g., phase shifter) circuits and digital processing techniques. To encompass both techniques, reference is sometimes made herein to “analog/RF beamforming” techniques and equipment. Configuring an antenna array to send and/or receive a beamformed signal may be referred to as “configuring spatial filter parameters of an antenna array.”

The terms “reconfigurable intelligent surface” and “RIS” are used herein to refer to any one or all of devices that may include a reflecting surface configured to be controlled to steer (or otherwise change the direction of) a reflected radio frequency (RF) wave, such as a carrier and/or subcarrier wave of a wireless network (e.g., LTE networks, 5G networks, later generation networks, etc.), a UE transmitted RF signal, etc. Steering a reflected RF wave may be accomplished by changing or controlling the angle of reflection of a reflected RF wave, such that the angle of transmission of the reflected RF wave off the reflecting surface is different than the angle of incidence of the incident RF wave on the reflecting surface. In some embodiments, a reflecting surface of a RIS may be an assembly of reflective antennas and controllable phase-shifting circuit elements in which the phase-shifting circuit elements can be controlled to shift the phase of an incident RF wave by a controlled phase shift amount so that a reflected (or retransmitted, or transmitted through signal reflection) RF wave emerges from the reflecting surface with an angle of reflection from the surface that is different from the angle of incidence of the incident RF wave. A reflecting surface of a RIS may be an assembly of reflective antennas and controllable phase-shifting circuit elements that is not connected to a transmitter, receiver, and/or transceiver and/or may be an assembly of reflective antennas and controllable phase-shifting circuit elements that does not provide electrical current resulting from an incident RF wave contacting the reflecting surface to and/or from a transmitter, receiver, and/or transceiver.

While a reflecting surface of a RIS may be controllable to result in a selected angle of reflection for a reflected RF wave, the reflecting surface of a RIS may be considered a passive surface in relation to RF communications purposes in that any electrical current generated in the reflecting surface of the RIS by an incident RF wave may not be used by the RIS for RF communications purposes. The reflecting surface of a RIS may act as a phased array antenna controlled to steer an incident RF wave in desired direction. A base station may control a RIS to steer an incident RF wave in a desired direction by providing analog beamforming weights to phase-shifting circuit elements of the RIS configured to reflect the RF wave in desired direction.

A RIS may be controlled to change a channel environment in a wireless network. For example, rather than transmitting signals directly to a UE, a base station may control a RIS to reflect a transmitted signal from the base station toward the UE. In such an example, the channel path may change from between the UE and base station to from the base station to the RIS and from the RIS to the UE. As a RIS may be controllable by a base station to steer a RF waveform, a base station may artificially induce a desired channel response by selecting a number of RISs in an environment and adapting the analog beamforming weights of the RIS. As another example, a base station may control a RIS to reflect one of multiple beams of RF signals toward a UE while one or more other beams are steered directly toward the UE, thereby supporting Multiple Input Multiple Output (MIMO) communication techniques between the base station and the UE.

Various embodiments may improve communication security in a wireless communication system by transmitting portions of a message along two or more different spatially separated signal paths. In some embodiments, a wireless device may divide a message into different portions and transmit to a second wireless device at a second location different the portions of the message via two or more different spatially separated signal paths in a manner that enables a second wireless device to receive the complete message. A third wireless device attempting to eavesdrop on the message at a third location that is different from the second location will be unable to receive all of the different portions of the message, and so the third wireless device will be unable to receive the complete message. The second wireless device may receive the different portions of the message via two or more different spatially separated signal paths, and may assemble the message from the received different portions of the message. Various embodiments provide communication security against an eavesdropping wireless device even when the location of the eavesdropping wireless device is unknown by the transmitting (the first) wireless device and/or the receiving (the second) wireless device.

In some embodiments, the wireless device may transmit different packets of the message via different multiple input multiple output (MIMO) beams. In this manner, the wireless device may distribute portions of the message among different physical signal beams. In some embodiments, the wireless device may further isolate the different MIMO beams. In some embodiments, the wireless device may transmit a first subset of packets of the message via a first MIMO beam directed toward the second wireless device, transmit a second subset of packets of the message via a second MIMO beam toward a reconfigurable intelligent surface (RIS), and control the RIS to transmit the second subset of packets towards the second wireless device through signal reflection. The receiving (second) wireless device may receive the first subset of packets of the message via the first MIMO beam from the second wireless device, and may receive the second subset of packets of the message via the second MIMO beam from the RIS.

In some embodiments, the wireless device may restrict aspects of packet retransmission to maintain the isolation of the portions of the message to different MIMO beams. In some embodiments, retransmission of a packet of the message may be restricted to the same MIMO beam on which the original packet (i.e., the packet being retransmitted) was transmitted. In this manner, an eavesdropping third wireless device would be unable to receive the complete message, or additional packets of the message, by intercepting retransmitted packets. The second wireless device may send a request for retransmission of one of the packets of the message, such as in response to unsuccessfully receiving one or more packets, and may receive retransmission of the one of the packets of the message via the same MIMO beam as the originally-sent one of the packets.

In some embodiments, the wireless device may determine a signal quality of wireless signals transmitted over the two or more different spatially separated signal paths. For example, the wireless device may determine a signal to interference plus noise ratio (SINR), a channel quality indication (CQI), or another indication of signal quality for the two or more different spatially separated signal paths. In some embodiments, the wireless device may allocate the different portions of the message for transmitting via the two or more different spatially separated signal paths based on the determined signal qualities of the two or more different spatially separated signal paths. For example, the wireless device may allocate more, or fewer, portions of the message to a spatially separated signal path based on the signal quality of the signal path.

In some embodiments, the message may be encrypted prior to transmitting the portions of the message along the two or more different spatially separated signal paths. In some embodiments, the wireless device may delay refreshing an encryption key, or may extend a period of use of an encryption key, when transmitting the portions of the message along the two or more different spatially separated signal paths, since an eavesdropping third wireless device will not receive at least some of the encrypted portions of the message. The second wireless device may receive encrypted different portions of the message sent from the first wireless device via two or more different spatially separated signal paths, and may combine the different portions to assemble the message and decrypt the assembled message.

In some embodiments, some messages may not be encrypted, such as control messages (e.g., Physical Downlink Control Channel (PDCCH) and Physical Uplink Control Channel (PUCCH) messages). For example, technical standards, or typical implementations of such messages, may not provide for or permit the encryption of such messages. In such embodiments, physical layer security according to various embodiments may provide communication security for messages such as control messages.

The wireless device may use a modulation scheme to encode the information in a message into signal patterns for transmission. In some embodiments, after performing a channel coding operation, the wireless device may divide the message into coded bits of the message. The wireless device may map the coded bits to different modulation points of a modulation scheme. In some embodiments, the wireless device may transmit coded bits of the message mapped to different modulation points via different beams in which each of the different beams transmits a corresponding one of the different modulation points. In some embodiments, the wireless device may aggregate modulation positions of a component constellation across a plurality of symbols to determine a constellation aggregation. The wireless device may partition the constellation aggregation into a plurality of subsets of symbols wherein each subset corresponds to a different beam. The wireless device may transmit each of the subsets of symbols via a corresponding one of a plurality of different spatially separated beams. In some embodiments, the wireless device may transmit each of the subsets of symbols via different holographic MIMO (H-MIMO) beams corresponding to the subsets of symbols. In some embodiments, the second (receiving) wireless device may receive the coded bits of the message via two or more different beams in which each beam corresponds to different modulation points of a modulation scheme.

In some embodiments, the second wireless device may receive the subsets of symbols via H-MIMO beams carrying the subsets of symbols.

Various embodiments improve the operation of wireless devices and communication systems by providing physical layer security for messages. Such physical layer security may be used in addition to other message security, such as encryption of the messages. By transmitting portions of a message along two or more different spatially separated signal paths, an eavesdropper may be prevented from receiving all of the message.

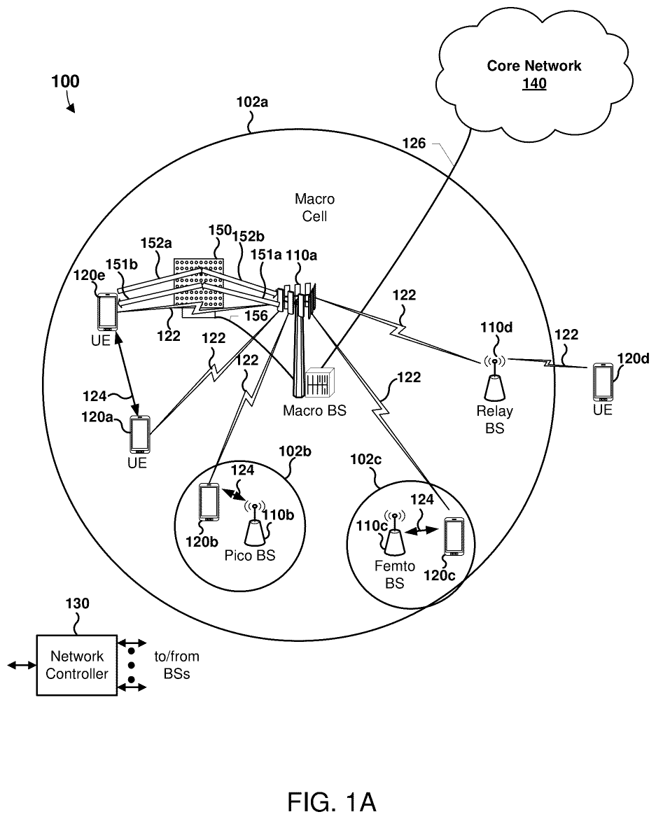

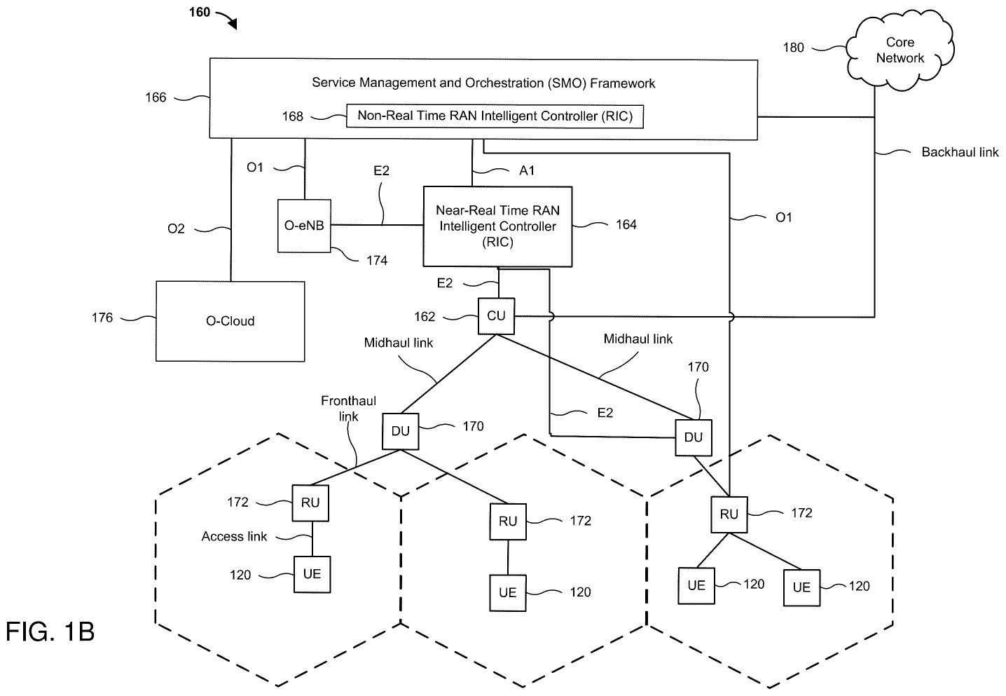

FIG. 1A is a system block diagram illustrating an example communications system 100 suitable for implementing any of the various embodiments. The communications system 100 may be a 5G New Radio (NR) network, or any other suitable network such as a Long Term Evolution (LTE) network. While FIG. 1A illustrates a 5G network, later generation networks may include the same or similar elements. Therefore, the reference to a 5G network and 5G network elements in the following descriptions is for illustrative purposes and is not intended to be limiting.

The communications system 100 may include a heterogeneous network architecture that includes a core network 140 and a variety of UEs (illustrated as UEs 120a-120e in FIG. 1A). The communications system 100 also may include a number of base stations (illustrated as the BS 110a, the BS 110b, the BS 110c, and the BS 110d) and other network entities. A base station is an entity that communicates with UEs, and also may be referred to as a Node B, an LTE Evolved nodeB (eNodeB or eNB), an access point (AP), a radio head, a transmit receive point (TRP), a New Radio base station (NR BS), a 5G NodeB (NB), a Next Generation NodeB (gNodeB or gNB), or the like. Each base station may provide communication coverage for a particular geographic area. In 3GPP, the term “cell” can refer to a coverage area of a base station, a base station subsystem serving this coverage area, or a combination thereof, depending on the context in which the term is used. The core network 140 may be any type core network, such as an LTE core network (e.g., an Evolved Packet Core (EPC) network), 5G core network, etc. The communications system 100 may also include one or more RISs (illustrated as RIS 150). A RIS may be an entity controlled by a base station, such as base station 110a, to steer (or otherwise change) an incident RF wave, such as a carrier and/or subcarrier wave, a UE transmitted RF signal, etc., such that an angle of reflection of a reflected RF wave resulting from reflecting the incident RF wave off a reflecting surface is different than an angle of incidence of the incident RF wave on the reflecting surface.

A base station 110a-110d may provide communication coverage for a macro cell, a pico cell, a femto cell, another type of cell, or a combination thereof. A macro cell may cover a relatively large geographic area (for example, several kilometers in radius) and may allow unrestricted access by UEs with a service subscription. A pico cell may cover a relatively small geographic area and may allow unrestricted access by UEs with service subscription. A femto cell may cover a relatively small geographic area (for example, a home) and may allow restricted access by UEs having association with the femto cell (for example, UEs in a closed subscriber group (CSG)). A base station for a macro cell may be referred to as a macro BS. A base station for a pico cell may be referred to as a pico BS. A base station for a femto cell may be referred to as a femto BS or a home BS. In the example illustrated in FIG. 1A, a base station 110a may be a macro BS for a macro cell 102a, a base station 110b may be a pico BS for a pico cell 102b, and a base station 110c may be a femto BS for a femto cell 102c. A base station 110a-110d may support one or multiple (for example, three) cells. The terms “eNB”, “base station”, “NR BS”, “gNB”, “TRP”, “AP”, “node B”, “5G NB”, and “cell” may be used interchangeably herein. A base station 110a-110d may control one or more RIS 150 in a cell.

In some examples, a cell may not be stationary, and the geographic area of the cell may move according to the location of a mobile base station. In some examples, the base stations 110a-110d may be interconnected to one another as well as to one or more other base stations or network nodes (not illustrated) and/or one or more RIS 150 in the communications system 100 through various types of backhaul interfaces, such as a direct physical connection, a virtual network, or a combination thereof using any suitable transport network.

The base station 110a-110d may communicate with the core network 140 over a wired or wireless communication link 126. The UEs 120a-120e may communicate with the base station 110a-110d over a wireless communication link 122. Additionally, the base station 110a-110d may communicate with the RIS 150 over a wired or wireless communication link 156.

The wired communication links 126, 156 may use a variety of wired networks (such as Ethernet, TV cable, telephony, fiber optic and other forms of physical network connections) that may use one or more wired communication protocols, such as Ethernet, Point-To-Point protocol, High-Level Data Link Control (HDLC), Advanced Data Communication Control Protocol (ADCCP), and Transmission Control Protocol/Internet Protocol (TCP/IP).

The communications system 100 also may include relay stations (such as relay BS 110d). A relay station is an entity that can receive a transmission of data from an upstream station (for example, a base station or a UE) and send a transmission of the data to a downstream station (for example, a UE or a base station). A relay station also may be a wireless device (e.g., a UE) that can relay transmissions for other UEs. In the example illustrated in FIG. 1A, a relay station 110d may communicate with macro the base station 110a and the UE 120d in order to facilitate communication between the base station 110a and the UE 120d. A relay station also may be referred to as a relay base station, a relay base station, a relay, etc.

The communications system 100 may be a heterogeneous network that includes base stations of different types, for example, macro base stations, pico base stations, femto base stations, relay base stations, etc. These different types of base stations may have different transmit power levels, different coverage areas, and different impacts on interference in communications system 100. For example, macro base stations may have a high transmit power level (for example, 5 to 40 Watts) whereas pico base stations, femto base stations, and relay base stations may have lower transmit power levels (for example, 0.1 to 2 Watts).

A network controller 130 may couple to a set of base stations and may provide coordination and control for these base stations. The network controller 130 may communicate with the base stations via a backhaul. The base stations also may communicate with one another, for example, directly or indirectly via a wireless or wireline backhaul.

The UEs 120a, 120b, 120c may be dispersed throughout the communications system 100, and each UE may be stationary or mobile. A UE also may be referred to as an access terminal, a terminal, a mobile station, a subscriber unit, a station, wireless device, etc.

A macro base station 110a may communicate with the communication network 140 over a wired or wireless communication link 126. The UEs 120a, 120b, 120c may communicate with a base station 110a-110d over a wireless communication link 122.

The wireless communication links 122 and 124 may include a plurality of carrier signals, frequencies, or frequency bands, each of which may include a plurality of logical channels. The wireless communication links 122 and 124 may utilize one or more radio access technologies (RATs). Examples of RATs that may be used in a wireless communication link include 3GPP LTE, 3G, 4G, 5G (such as NR), GSM, Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links within the communication system 100 include medium range protocols such as Wi-Fi, LTE-U, LTE-Direct, LAA, MuLTEfire, and relatively short range RATs such as ZigBee, Bluetooth, and Bluetooth Low Energy (LE).

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block”) may be 12 subcarriers (or 180 kHz). Consequently, the nominal Fast File Transfer (FFT) size may be equal to 128, 256, 512, 1024 or 2048 for system bandwidth of 1.25, 2.5, 5, 10 or 20 megahertz (MHZ), respectively. The system bandwidth also may be partitioned into subbands. For example, a subband may cover 1.08 MHZ (i.e., 6 resource blocks), and there may be 1, 2, 4, 8 or 16 subbands for system bandwidth of 1.25, 2.5, 5, 10 or 20 MHZ, respectively.

While descriptions of some implementations may use terminology and examples associated with LTE technologies, some implementations may be applicable to other wireless communications systems, such as a new radio (NR) or 5G network. NR may utilize OFDM with a cyclic prefix (CP) on the uplink (UL) and downlink (DL) and include support for half-duplex operation using time division duplex (TDD). A single component carrier bandwidth of 100 MHz may be supported. NR resource blocks may span 12 sub-carriers with a sub-carrier bandwidth of 75 kHz over a 0.1 millisecond (ms) duration. Each radio frame may consist of 50 subframes with a length of 10 ms. Consequently, each subframe may have a length of 0.2 ms. Each subframe may indicate a link direction (i.e., DL or UL) for data transmission and the link direction for each subframe may be dynamically switched. Each subframe may include DL/UL data as well as DL/UL control data. Beamforming may be supported and beam direction may be dynamically configured. Multiple Input Multiple Output (MIMO) transmissions with precoding also may be supported. MIMO configurations in the DL may support up to eight transmit antennas with multi-layer DL transmissions up to eight streams and up to two streams per UE. Multi-layer transmissions with up to 2 streams per UE may be supported.

Aggregation of multiple cells may be supported with up to eight serving cells. Alternatively, NR may support a different air interface, other than an OFDM-based air interface.

Some UEs may be considered machine-type communication (MTC) or evolved or enhanced machine-type communication (eMTC) UEs. MTC and eMTC UEs include, for example, robots, drones, remote devices, sensors, meters, monitors, location tags, etc., that may communicate with a base station, another device (for example, remote device), or some other entity. A wireless computing platform may provide, for example, connectivity for or to a network (for example, a wide area network such as Internet or a cellular network) via a wired or wireless communication link. Some UEs may be considered Internet-of-Things (IoT) devices or may be implemented as NB-IoT (narrowband internet of things) devices. The UE 120a-120e may be included inside a housing that houses components of the UE 120a-120e, such as processor components, memory components, similar components, or a combination thereof.

In general, any number of communications systems and any number of wireless networks may be deployed in a given geographic area. Each communications system and wireless network may support a particular radio access technology (RAT) and may operate on one or more frequencies. A RAT also may be referred to as a radio technology, an air interface, etc. A frequency also may be referred to as a carrier, a frequency channel, etc. Each frequency may support a single RAT in a given geographic area in order to avoid interference between communications systems of different RATs. In some cases, 4G/LTE and/or 5G/NR RAT networks may be deployed. For example, a 5G non-standalone (NSA) network may utilize both 4G/LTE RAT in the 4G/LTE RAN side of the 5G NSA network and 5G/NR RAT in the 5G/NR RAN side of the 5G NSA network. The 4G/LTE RAN and the 5G/NR RAN may both connect to one another and a 4G/LTE core network (e.g., an evolved packet core (EPC) network) in a 5G NSA network. Other example network configurations may include a 5G standalone (SA) network in which a 5G/NR RAN connects to a 5G core network.

In some implementations, two or more UEs (for example, illustrated as the UE 120a and the UE 120e) may communicate directly using one or more sidelink channels (for example, without using a base station 110a-d as an intermediary to communicate with one another). For example, the UEs 120a-120e may communicate using peer-to-peer (P2P) communications, device-to-device (D2D) communications, a vehicle-to-everything (V2X) protocol (which may include a vehicle-to-vehicle (V2V) protocol, a vehicle-to-infrastructure (V2I) protocol, or similar protocol), a mesh network, or similar networks, or combinations thereof. In this case, the UE 120a-120e may perform scheduling operations, resource selection operations, as well as other operations described elsewhere herein as being performed by the base station 110a-110d.

In some implementations, a UE and a base station (for example, illustrated as the UE 120e and the base station 110a) may communicate via reflections off a RIS, such as RIS 150. For example, the base station 110a may transmit a communication signal 151a (e.g., in the downlink path) in the direction of the RIS 150 and the RIS 150 may reflect the communication signal as a reflected communication signal 151b to the UE 120e. Similarly, the UE 120e may transmit a communication signal to 152a (e.g., in the uplink path) in the direction of the RIS 150 and the RIS 150 may reflect the communication signal as a reflected communication signal 152b to the base station 110a. In some cases, the UE 120e and base station 110a may establish a wireless communication link 122 with one another via the transmitted signals 151a and 152a and the reflected signals 151b and 152b.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or components) performing base station functionality, may be implemented in an aggregated or disaggregated architecture. For example, a base station (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or as a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CUS, DUs and RUS also can be implemented as virtual units, referred to as a virtual central unit (VCU), a virtual distributed unit (VDU), or a virtual radio unit (VRU).

Base station-type operations or network design may consider aggregation characteristics of base station functionality. For example, disaggregated base stations may be utilized in an integrated access backhaul (IAB) network, an open radio access network (O-RAN) (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 1B is a system block diagram illustrating an example disaggregated base station 160 architecture suitable for implementing any of the various embodiments. The disaggregated base station 160 architecture may include one or more central units (CUs) 162 that can communicate directly with a core network 180 via a backhaul link, or indirectly with the core network 180 through one or more disaggregated base station units, such as a Near-Real Time (Near-RT) RAN Intelligent Controller (RIC) 164 via an E2 link, or a Non-Real Time (Non-RT) RIC 168 associated with a Service Management and Orchestration (SMO) Framework 166, or both. A CU 162 may communicate with one or more distributed units (DUs) 170 via respective midhaul links, such as an F1 interface. The DUs 170 may communicate with one or more radio units (RUS) 172 via respective fronthaul links. The RUs 172 may communicate with respective UEs 120 via one or more radio frequency (RF) access links. In some implementations, the UE 120 may be simultaneously served by multiple RUs 172.

Each of the units (i.e., CUs 162, DUs 170, RUs 172), as well as the Near-RT RICs 164, the Non-RT RICs 168 and the SMO Framework 166, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 162 may host one or more higher layer control functions. Such control functions may include the radio resource control (RRC), packet data convergence protocol (PDCP), service data adaptation protocol (SDAP), or the like. Each control function may be implemented with an interface configured to communicate signals with other control functions hosted by the CU 162. The CU 162 may be configured to handle user plane functionality (i.e., Central Unit-User Plane (CU-UP)), control plane functionality (i.e., Central Unit-Control Plane (CU-CP)), or a combination thereof. In some implementations, the CU 162 can be logically split into one or more CU-UP units and one or more CU-CP units. The CU-UP unit can communicate bidirectionally with the CU-CP unit via an interface, such as the E1 interface when implemented in an O-RAN configuration. The CU 162 can be implemented to communicate with DUs 170, as necessary, for network control and signaling.

The DU 170 may correspond to a logical unit that includes one or more base station functions to control the operation of one or more RUs 172. In some aspects, the DU 170 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 170 may further host one or more low PHY layers. Each layer (or module) may be implemented with an interface configured to communicate signals with other layers (and modules) hosted by the DU 170, or with the control functions hosted by the CU 162.

Lower-layer functionality may be implemented by one or more RUs 172. In some deployments, an RU 172, controlled by a DU 170, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 172 may be implemented to handle over the air (OTA) communication with one or more UEs 120. In some implementations, real-time and non-real-time aspects of control and user plane communication with the RU(s) 172 may be controlled by the corresponding DU 170. In some scenarios, this configuration may enable the DU(s) 170 and the CU 162 to be implemented in a cloud-based RAN architecture, such as a vRAN architecture.

The SMO Framework 166 may be configured to support RAN deployment and provisioning of non-virtualized and virtualized network elements. For non-virtualized network elements, the SMO Framework 166 may be configured to support the deployment of dedicated physical resources for RAN coverage requirements, which may be managed via an operations and maintenance interface (such as an O1 interface). For virtualized network elements, the SMO Framework 166 may be configured to interact with a cloud computing platform (such as an open cloud (O-Cloud) 176) to perform network element life cycle management (such as to instantiate virtualized network elements) via a cloud computing platform interface (such as an O2 interface). Such virtualized network elements can include, but are not limited to, CUs 162, DUs 170, RUs 172 and Near-RT RICs 164. In some implementations, the SMO Framework 166 may communicate with a hardware aspect of a 4G RAN, such as an open eNB (O-eNB) 174, via an O1 interface. Additionally, in some implementations, the SMO Framework 166 may communicate directly with one or more RUs 172 via an O1 interface. The SMO Framework 166 also may include a Non-RT RIC 168 configured to support functionality of the SMO Framework 166.

The Non-RT RIC 168 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 164. The Non-RT RIC 168 may be coupled to or communicate with (such as via an A1 interface) the Near-RT RIC 164. The Near-RT RIC 164 may be configured to include a logical function that enables near-real-time control and optimization of RAN elements and resources via data collection and actions over an interface (such as via an E2 interface) connecting one or more CUs 162, one or more DUs 170, or both, as well as an O-eNB, with the Near-RT RIC 164.

In some implementations, to generate AI/ML models to be deployed in the Near-RT RIC 164, the Non-RT RIC 168 may receive parameters or external enrichment information from external servers. Such information may be utilized by the Near-RT RIC 164 and may be received at the SMO Framework 166 or the Non-RT RIC 168 from non-network data sources or from network functions. In some examples, the Non-RT RIC 168 or the Near-RT RIC 164 may be configured to tune RAN behavior or performance. For example, the Non-RT RIC 168 may monitor long-term trends and patterns for performance and employ AI/ML models to perform corrective actions through the SMO Framework 166 (such as reconfiguration via 01) or via creation of RAN management policies (such as A1 policies).

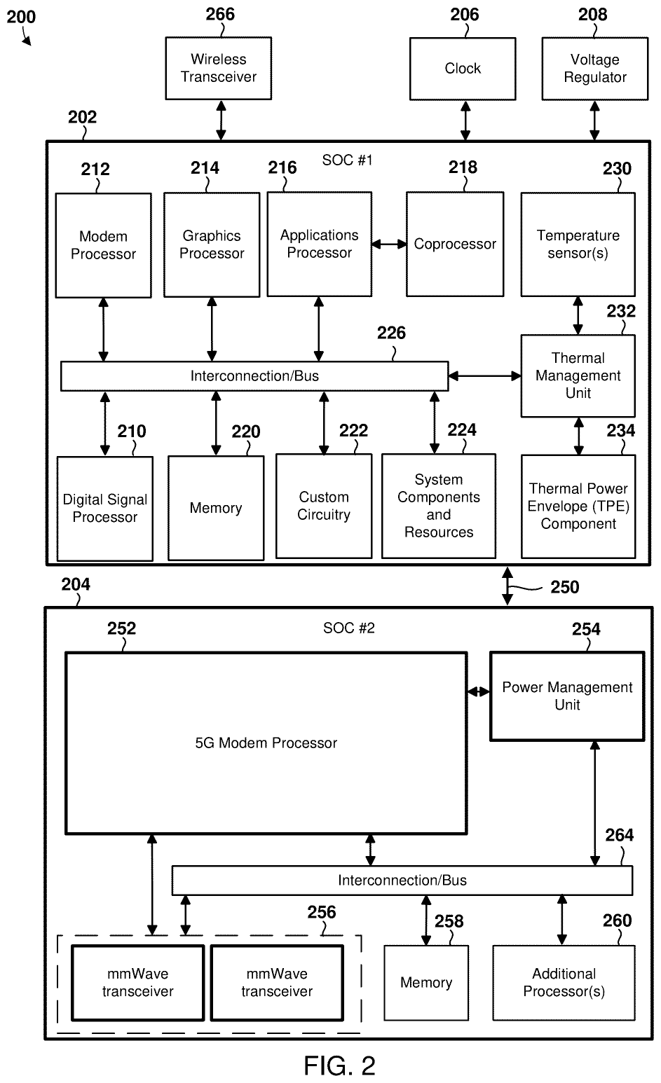

FIG. 2 is a component block diagram illustrating an example computing and wireless modem system 200 suitable for implementing any of the various embodiments. Various embodiments may be implemented on a number of single processor and multiprocessor computer systems, including a system-on-chip (SOC) or system in a package (SIP).

With reference to FIGS. 1A-2, the illustrated example computing system 200 (which may be a SIP in some embodiments) includes a two SOCs 202, 204 coupled to a clock 206, a voltage regulator 208, and a wireless transceiver 266 configured to send and receive wireless communications via an antenna (not shown) to/from other devices, such as UEs (e.g., UE 120a-120e), network devices (e.g., base stations 110a-110d), etc. In some implementations, the first SOC 202 may operate as central processing unit (CPU) of the UE that carries out the instructions of software application programs by performing the arithmetic, logical, control and input/output (I/O) operations specified by the instructions. In some implementations, the second SOC 204 may operate as a specialized processing unit. For example, the second SOC 204 may operate as a specialized 5G processing unit responsible for managing high volume, high speed (such as 5 Gbps, etc.), or very high frequency short wave length (such as 28 GHz mmWave spectrum, etc.) communications.

The first SOC 202 may include a digital signal processor (DSP) 210, a modem processor 212, a graphics processor 214, an application processor 216, one or more coprocessors 218 (such as vector co-processor) connected to one or more of the processors, memory 220, custom circuity 222, system components and resources 224, an interconnection/bus module 226, one or more temperature sensors 230, a thermal management unit 232, and a thermal power envelope (TPE) component 234. The second SOC 204 may include a 5G modem processor 252, a power management unit 254, an interconnection/bus module 264, a plurality of mmWave transceivers 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SOC 202 may include a processor that executes a first type of operating system (such as FreeBSD, LINUX, OS X, etc.) and a processor that executes a second type of operating system (such as MICROSOFT WINDOWS 10). In addition, any or all of the processors 210, 212, 214, 216, 218, 252, 260 may be included as part of a processor cluster architecture (such as a synchronous processor cluster architecture, an asynchronous or heterogeneous processor cluster architecture, etc.).

The first and second SOC 202, 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SOC 202 may include power amplifiers, voltage regulators, oscillators, phase-locked loops, peripheral bridges, data controllers, memory controllers, system controllers, access ports, timers, and other similar components used to support the processors and software clients running on a UE. The system components and resources 224 or custom circuitry 222 also may include circuitry to interface with peripheral devices, such as cameras, electronic displays, wireless communication devices, external memory chips, etc.

The first and second SOC 202, 204 may communicate via interconnection/bus module 250. The various processors 210, 212, 214, 216, 218, may be interconnected to one or more memory elements 220, system components and resources 224, and custom circuitry 222, and a thermal management unit 232 via an interconnection/bus module 226. Similarly, the processor 252 may be interconnected to the power management unit 254, the mmWave transceivers 256, memory 258, and various additional processors 260 via the interconnection/bus module 264. The interconnection/bus module 226, 250, 264 may include an array of reconfigurable logic gates or implement a bus architecture (such as CoreConnect, AMBA, etc.). Communications may be provided by advanced interconnects, such as high-performance networks-on chip (NoCs).

The first or second SOCs 202, 204 may further include an input/output module (not illustrated) for communicating with resources external to the SOC, such as a clock 206 and a voltage regulator 208. Resources external to the SOC (such as clock 206, voltage regulator 208) may be shared by two or more of the internal SOC processors/cores.

In addition to the example SIP 200 discussed above, some implementations may be implemented in a wide variety of computing systems, which may include a single processor, multiple processors, multicore processors, or any combination thereof.

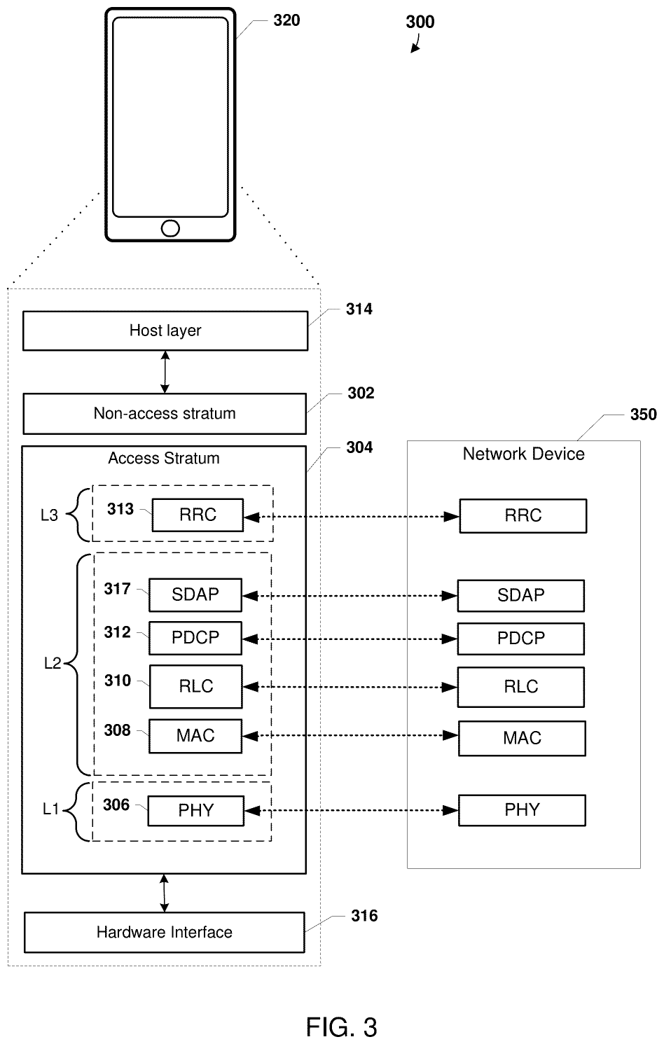

FIG. 3 is a component block diagram illustrating a software architecture 300 including a radio protocol stack for the user and control planes in wireless communications suitable for implementing any of the various embodiments. With reference to FIGS. 1A-3, the UE 320 may implement the software architecture 300 to facilitate communication between a UE 320 (e.g., the UE 120a-120e, 200) and a network device 350 (e.g., base station 110a-110d) of a communication system (e.g., 100). In various embodiments, layers in software architecture 300 may form logical connections with corresponding layers in software of the network device 350. The software architecture 300 may be distributed among one or more processors (e.g., the processors 212, 214, 216, 218, 252, 260). While illustrated with respect to one radio protocol stack, in a multi-SIM (subscriber identity module) UE, the software architecture 300 may include multiple protocol stacks, each of which may be associated with a different SIM (e.g., two protocol stacks associated with two SIMs, respectively, in a dual-SIM wireless communication device). While described below with reference to LTE communication layers, the software architecture 300 may support any of variety of standards and protocols for wireless communications, and/or may include additional protocol stacks that support any of variety of standards and protocols wireless communications.

The software architecture 300 may include a Non-Access Stratum (NAS) 302 and an Access Stratum (AS) 304. The NAS 302 may include functions and protocols to support packet filtering, security management, mobility control, session management, and traffic and signaling between a SIM(s) of the UE (such as SIM(s) 204) and its core network 140. The AS 304 may include functions and protocols that support communication between a SIM(s) (such as SIM(s) 204) and entities of supported access networks (such as a base station). In particular, the AS 304 may include at least three layers (Layer 1, Layer 2, and Layer 3), each of which may contain various sub-layers.

In the user and control planes, Layer 1 (L1) of the AS 304 may be a physical layer (PHY) 306, which may oversee functions that enable transmission or reception over the air interface via a wireless transceiver (e.g., 266). Examples of such physical layer 306 functions may include cyclic redundancy check (CRC) attachment, coding blocks, scrambling and descrambling, modulation and demodulation, signal measurements, MIMO, etc. The physical layer may include various logical channels, including the Physical Downlink Control Channel (PDCCH) and the Physical Downlink Shared Channel (PDSCH).

In the user and control planes, Layer 2 (L2) of the AS 304 may be responsible for the link between the UE 320 and the network device 350 over the physical layer 306. In some implementations, Layer 2 may include a media access control (MAC) sublayer 308, a radio link control (RLC) sublayer 310, and a packet data convergence protocol (PDCP) 312 sublayer, and a Service Data Adaptation Protocol (SDAP) 317 sublayer each of which form logical connections terminating at the network device 350.

In the control plane, Layer 3 (L3) of the AS 304 may include a radio resource control (RRC) sublayer 3. While not shown, the software architecture 300 may include additional Layer 3 sublayers, as well as various upper layers above Layer 3. In some implementations, the RRC sublayer 313 may provide functions including broadcasting system information, paging, and establishing and releasing an RRC signaling connection between the UE 320 and the network device 350.

In various embodiments, the SDAP sublayer 317 may provide mapping between Quality of Service (QOS) flows and data radio bearers (DRBs). In some implementations, the PDCP sublayer 312 may provide uplink functions including multiplexing between different radio bearers and logical channels, sequence number addition, handover data handling, integrity protection, ciphering, and header compression. In the downlink, the PDCP sublayer 312 may provide functions that include in-sequence delivery of data packets, duplicate data packet detection, integrity validation, deciphering, and header decompression.

In the uplink, the RLC sublayer 310 may provide segmentation and concatenation of upper layer data packets, retransmission of lost data packets, and Automatic Repeat Request (ARQ). In the downlink, while the RLC sublayer 310 functions may include reordering of data packets to compensate for out-of-order reception, reassembly of upper layer data packets, and ARQ.

In the uplink, MAC sublayer 308 may provide functions including multiplexing between logical and transport channels, random access procedure, logical channel priority, and hybrid-ARQ (HARQ) operations. In the downlink, the MAC layer functions may include channel mapping within a cell, de-multiplexing, discontinuous reception (DRX), and HARQ operations.

While the software architecture 300 may provide functions to transmit data through physical media, the software architecture 300 may further include at least one host layer 314 to provide data transfer services to various applications in the UE 320. In some implementations, application-specific functions provided by the at least one host layer 314 may provide an interface between the software architecture and the general purpose processor 206.

In other implementations, the software architecture 300 may include one or more higher logical layer (such as transport, session, presentation, application, etc.) that provide host layer functions. For example, in some implementations, the software architecture 300 may include a network layer (such as Internet protocol (IP) layer) in which a logical connection terminates at a packet data network (PDN) gateway (PGW). In some implementations, the software architecture 300 may include an application layer in which a logical connection terminates at another device (such as end user device, server, etc.). In some implementations, the software architecture 300 may further include in the AS 304 a hardware interface 316 between the physical layer 306 and the communication hardware (such as one or more radio frequency (RF) transceivers).

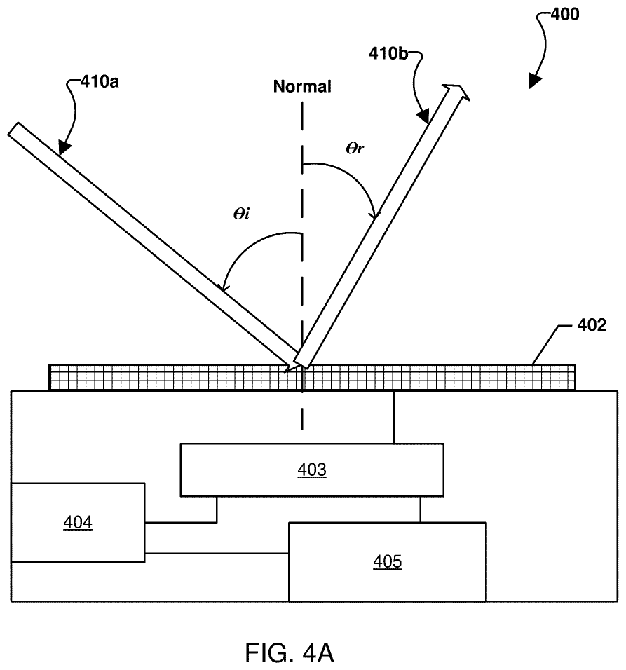

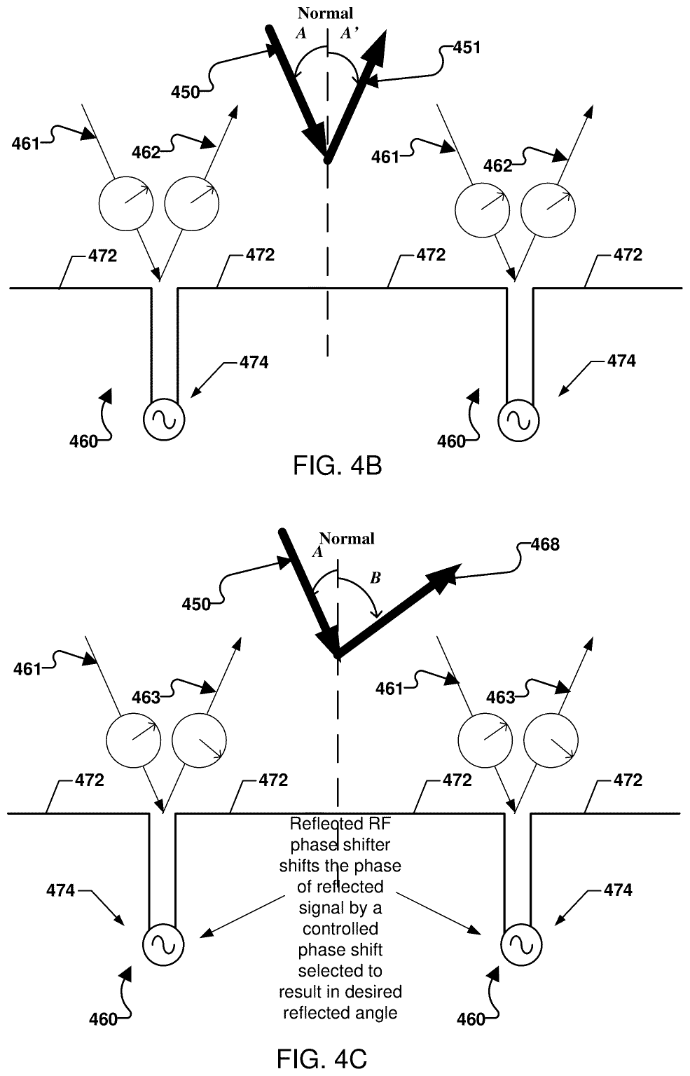

FIG. 4A is a block diagram of an example of a RIS 400 suitable for implementing any of the various embodiments. With reference to FIGS. 1A-4A, the RIS 400 (e.g., RIS 150) may include a reflective surface 402, such as an array of antenna elements, connected to a controller, such as a processor 403. The processor 403 may be connected to a power source 404, such as a battery, power connection to a power grid, connection to a solar panel, etc. The processor 403 may be coupled to a network access port 405 (or interface) for establishing data connections with a network, such as the Internet or a local area network, coupled to other network devices, such as a base station (e.g., 110a-110d, 350).

The processor 403 may receive messages and/or instructions from a network device, such as a base station (e.g., 110a-110d, 350) via the network access port 405. The received messages and/or instructions may include indications of steering parameters, such as analog beamforming weights, indications of selected angles of reflection, selected directions, etc.

The reflective surface 402 may include one or more antenna and controllable phase-shifting circuit elements as illustrated in FIGS. 4B and 4C. The one or more antenna and controllable phase-shifting circuit elements may be organized into one or more arrays of elements. The individual antenna and controllable phase-shifting circuit elements and/or groups of elements within an array may be controllable to change a phase of a RF wave (or RF signal) incident on the reflective surface 402 such that that an angle of reflection (θr) of a reflected RF wave 410b resulting from reflecting an incident RF wave 410a off the reflecting surface 402 is different than an angle of incidence (θi) of the incident RF wave 410a on the reflecting surface. The processor 403 may provide current and/or voltages and/or control signals to the phase-shifting circuit elements of the reflective surface 402 to control the phase shift imparted by a phase shift controller of the one or more antenna and controllable phase-shifting circuit elements. Antenna and controllable phase-shifting circuit elements and/or arrays of antenna and controllable phase-shifting circuit elements of the reflecting surface 402 may be individually controlled by the processor 403. Controlling different antenna and controllable phase-shifting circuit elements and/or different arrays of antenna and controllable phase-shifting circuit elements differently may enable the reflecting surface 402 to operate as different panels of a phase array antenna.

While only a single reflective surface 402 is illustrated in FIG. 4A, a RIS may include more than one reflective surface 402. As illustrated in FIG. 4A, the reflecting surface 402 may not be connected to a transmitter, receiver, and/or transceiver and/or may be a surface of antenna and controllable phase-shifting circuit elements that does not provide electrical current resulting from an incident RF wave 410a contacting the reflecting surface 402 to and/or from a transmitter, receiver, and/or transceiver. While phase-shifting circuit elements of the reflecting surface 402 may be controllable to result in a selected angle of reflection (θr) for a reflected RF wave 410b, the reflecting surface 402 may be considered a passive reflective surface for RF communications purposes in that any electrical current generated in the reflecting surface 402 by an incident RF wave 410a may not be used by the RIS 400 for RF communications purposes.

FIGS. 4B and 4C illustrate aspects of an incident RF wave 450 reflected from a portion of a RIS reflecting surface 402 including two elements 460 each including an antenna portion 472 and a phase-shifter circuit element 474 suitable for implementing any of the various embodiments. With reference to FIGS. 1-4C, the illustrated portion of the RIS (e.g., RIS 150, 400) in FIG. 4B shows reflection of the incident RF wave 450 without a change in RF phase, and the illustrated portion of the RIS in FIG. 4C shows reflection of the incident RF wave 450 with a change in RF phase applied to steer a reflected RF wave 468. The phase of the incident RF wave 450 is illustrated by phase direction 461. The angle of incidence of the RF wave 450 is measured from the normal of the reflective surface and is represented by the angle A. As no change in RF phase is applied in FIG. 4B, the incident RF wave 450 is reflected as reflected wave 451 having an angle of reflection A′ that is the same as the angle of incidence A. The phase of the reflected RF wave 451 is illustrated by the phase direction 462. The phase directions 461 and 462 are the same as no phase shift is applied in the example illustrated in FIG. 4B.

In the example illustrated in FIG. 4C, a phase shift is applied by the phase-shifting circuit elements 474 to steer the reflected RF wave 468. Specifically, the phase-shifter circuit element 474 of each element 460 may apply a phase shift that changes the direction of the reflected RF wave 468 to a phase direction 463. Thus, the phase-shifter circuit elements 474 induce a phase shift in the reflected RF wave 468 that causes the phase direction 463 to be different than the phase direction 461. The shift in phase direction steers the reflected RF wave 468 such that the reflected RF wave 468 has an angle of reflection B that is different than the angle of incidence A. The amount of phase shift applied by the phase-shifting circuit element 474 in each element 460 may be controlled by a processor (e.g., processor 403) controlling the phase-shifting circuit elements 474 in each element 460 to steer the reflected RF wave 468 in a selected direction. The steering of the reflected RF wave 468 may be controlled by a processor (e.g., processor 403) controlling the phase-shifting circuit element 474 in each element 460 according to steering parameters, such as analog beamforming weights, indications of selected angles of reflection, selected directions, etc., provided to the RIS (e.g., RIS 150, 400) by a network device (e.g., base station 110a-110d, 350, etc.).

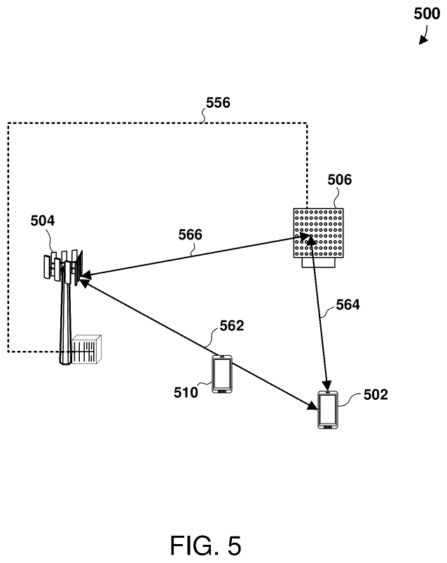

FIG. 5 is a system conceptual diagram illustrating example operations 500 for providing communication security at a physical layer in a wireless communication system (e.g., 100) according to various embodiments. With reference to FIGS. 1A-5, a base station 504 (e.g., base station 110a-110d, 350) and a UE 502 (e.g., wireless device 120a-120e, 320) may communicate via a signal that is transmitted via two or more different spatially separated signal paths. The base station 504 may control a RIS 506 (e.g., RIS 150, 400) with messages sent via a communication link 556 (e.g., wired or wireless communication link 156). Signal path 562 represents a line of sight path between the base station 504 and the wireless device 502. Signal paths 564 and 566 represent a reflected signal path of signals that are sent to and reflected from the RIS 506.

In some embodiments, the reflected signal path (564, 566) may be created by identifying an appropriate phase shift for the RIS 506 such that an incoming signal from a first wireless device (e.g., the base station 504 or the UE 502) can be reflected towards a second wireless device (e.g., the UE 502 or the base station 504). The base station 504 and the RIS 506 may be configured appropriately to enable the sending, receiving, and reflection of the reflected signal path, and the reflected signal path may be used for uplink and/or downlink messages or signals.

An eavesdropping wireless device 510 (a third wireless device) may attempt to eavesdrop on communications between the UE 502 and the base station 504 by intercepting signals sent along the signal path 562. However, the UE 502 and/or the base station 504 may send different portions of a message along the line of sight signal path 562 and the reflected signal path 564, 566. While the eavesdropping wireless device 510 may receive one or more portions of the messages sent along the line of sight signal path 562, the eavesdropping wireless device 510 does not receive a signal of sufficiently high signal strength or quality to receive the one or more portions of the messages sent along the reflected signal path 564, 566. In this manner, use of the line of sight signal path 562 and the reflected signal path 564, 566 may improve communication security between the UE 502 and the base station 504. In particular, security between the UE 502 and the base station 504 is improved when the line of sight signal path 562 and the reflected signal path 564, 566 use highly directional beams to send and receive signals.

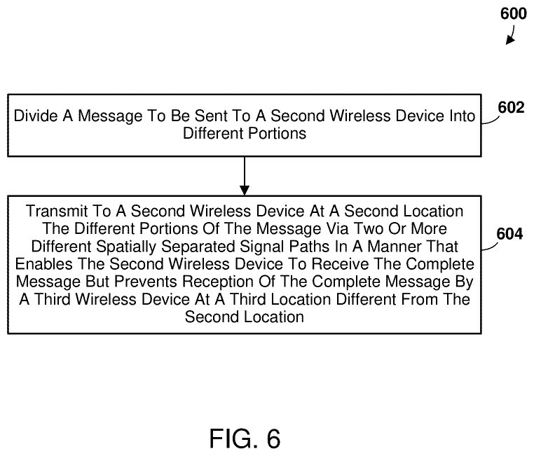

FIG. 6 is a process flow diagram illustrating a method 600 for providing communication security at a physical layer that may be performed by a processor of a wireless device according to various embodiments. With reference to FIGS. 1A-6, the operations of the method 600 may be performed by a processor (such as the processor 210, 212, 214, 216, 218, 252, 260) of a wireless device (e.g., 110a, 110a-110d, 120a-120e, 320, 350, 502, 504).

In block 602, the processor may divide a message that is to be sent to a second wireless device at a second location into different portions. The second location of the second may be physically separated from the first location of the first wireless device. In some embodiments, the processor may divide the message into a plurality of bits or packets. In some embodiments, the processor may device the message into different groups of bits to be encoded into specific subsets of the modulation constellation. Means for performing the operations of block 604 may include the processor 210, 212, 214, 216, 218, 252, 260.

In block 604, the processor may transmit to the second wireless device at the second location the different portions of the message via two or more different spatially separated signal paths in a manner that enables the second wireless device to receive the complete message but prevents reception of the complete message by a third wireless device at a third location different from the second location. In embodiments in which the processor divides the message into a plurality of bits or packets, and the processor may allocate bits to the two or more different spatially separated signal paths. In some embodiments, the processor may allocate the bits or packets according to a static mapping of bits to signal paths. In some embodiments, the processor may allocate the bits or packets according to a dynamic mapping of bits to signal paths, such as a pseudorandom mapping that may vary over time. In various embodiments, the packets may include Medium Access Control (MAC) packets, Radio Link Control (RLC) packets, Packet Data Convergence Protocol (PDCP) packets, or other suitable packets. Means for performing the operations of block 604 may include the processor 210, 212, 214, 216, 218, 252, 260 and the wireless transceiver 266.

In some embodiments, the processor may encrypt the message prior to transmitting the different portions of a message via the two or more different spatially separated signal paths. For example, the processor may encrypt the message at a layer other than the physical layer (e.g., an application layer), and then provide the encrypted message to the physical layer for transmission from the wireless device. In some embodiments, the processor may transmit portions of the encrypted message to the second wireless device via the two or more different spatially separated signal paths.

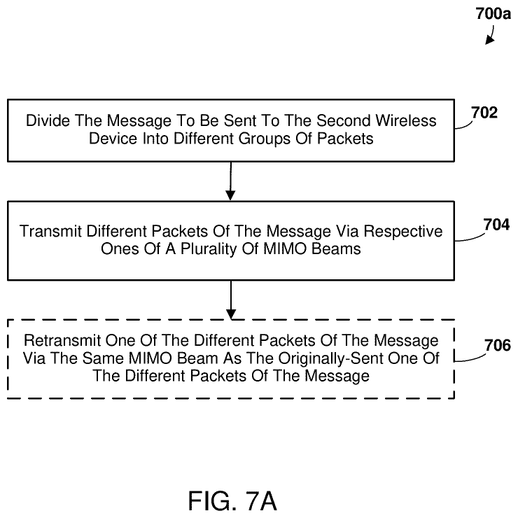

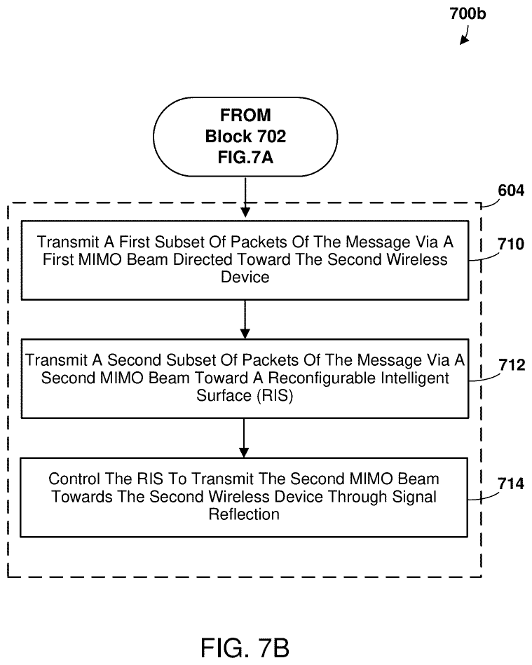

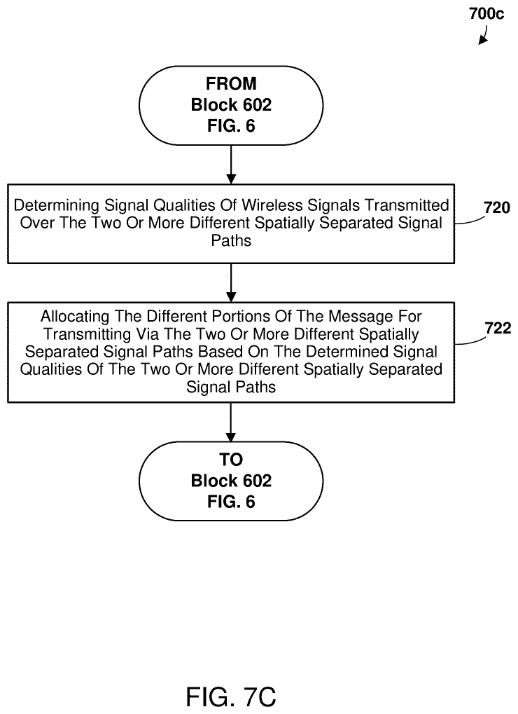

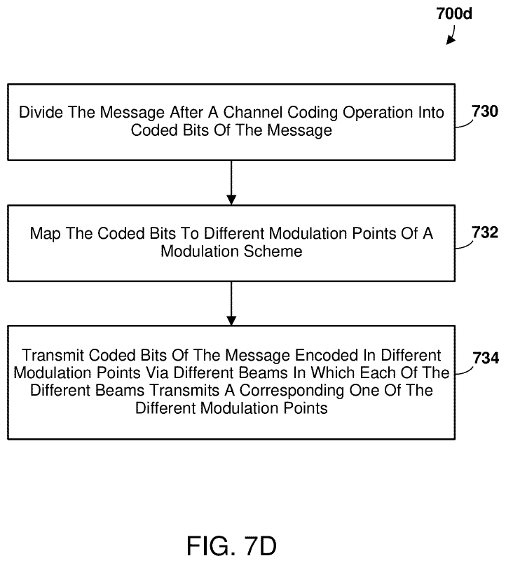

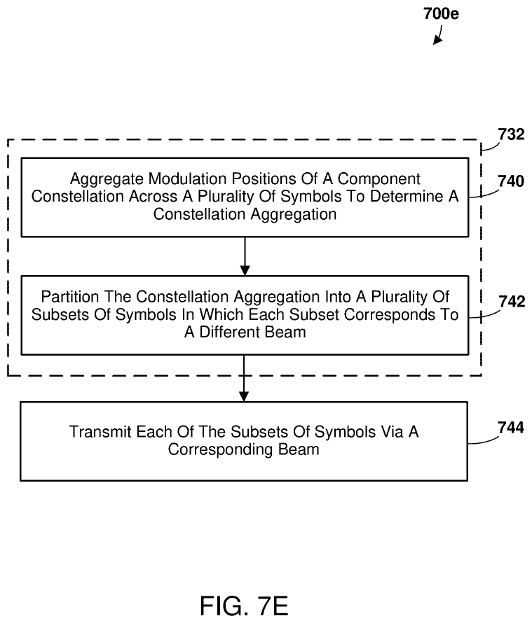

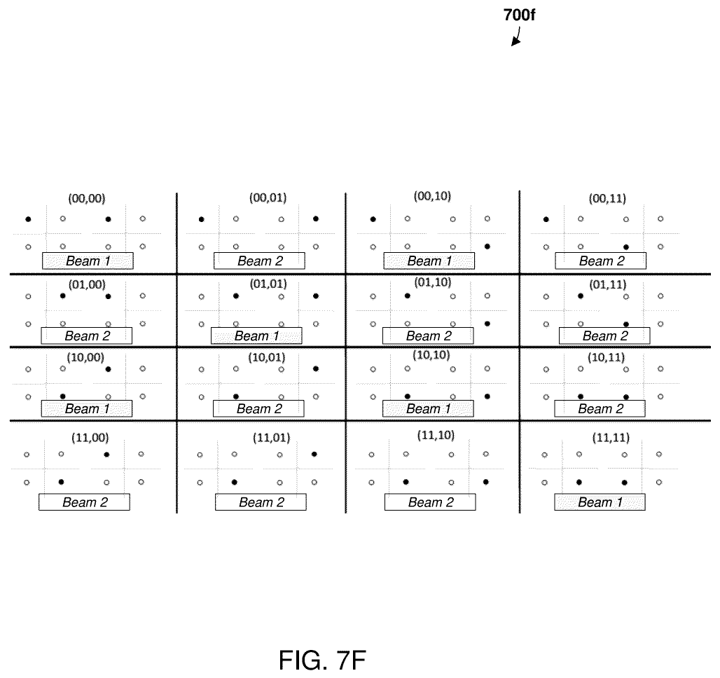

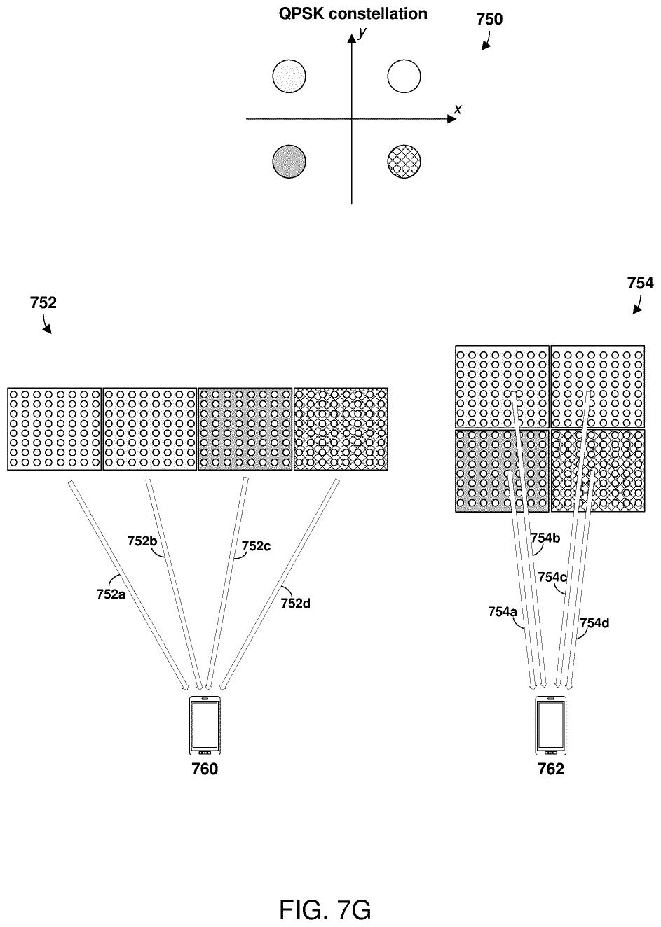

FIGS. 7A-7E are process flow diagrams illustrating operations 700a-700e that may be performed as part of the method 600 for providing communication security at a physical layer that may be performed by a processor of a wireless device according to various embodiments. With reference to FIGS. 1A-7E, the operations 700a-700e may be performed by a processor (such as the processor 210, 212, 214, 216, 218, 252, 260) of a wireless device (e.g., 110a, 110a-110d, 120a-120e, 320, 350, 502, 504).

Referring to the operations 700a illustrated in FIG. 7A, in block 702, the processor may divide the message to be sent to the second wireless device into different groups of packets. In some embodiments, the processor may divide the message to be sent to the second wireless device before channel coding into the different portions. Means for performing the operations of block 702 may include the processor 210, 212, 214, 216, 218, 252, 260.

In block 704, the processor may transmit the different packets of the message via respective ones of a plurality of MIMO beams. In some embodiments, the processor may transmit different packets in the different MIMO beams according to a signal quality of each of the different MIMO beams. For example, the processor may determine a signal quality of two or more MIMO beams, and may allocate to the two or more MIMO beams packets of the message based on the determined signal quality of the two or more MIMO beams. Means for performing the operations of block 702 may include the processor 210, 212, 214, 216, 218, 252, 260 and the wireless transceiver 266.

In optional block 706, the processor may retransmit one of the different packets of the message via the same MIMO beam as the originally-sent one of the different packets of the message. In some embodiments, the processor may constrain retransmission of a packet to the MIMO beam by which the original packet was sent. In this manner, an eavesdropper may be prevented from receiving the entire message by receiving some portions of the messages as transmitted packets and other portions of the message as retransmitted packets via one signal path. Means for performing the operations of block 704 may include the processor 210, 212, 214, 216, 218, 252, 260 and the wireless transceiver 266.

Referring to the operations 700b illustrated in FIG. 7B, after dividing the message into different groups of packets in block 702 of the method 700b as described, the processor may transmit a first subset of packets of the message via a first MIMO beam directed toward the second wireless device in block 710. For example, the processor may transmit a first subset of packets of the message via a first MIMO beam via the line of sight signal path 562. Means for performing the operations of block 710 may include the processor 210, 212, 214, 216, 218, 252, 260 and the wireless transceiver 266.

In block 712, the processor may transmit a second subset of packets of the message via a second MIMO beam toward a RIS (e.g., 150, 400, 506). For example, the processor may transmit a second subset of packets of the message via a second MIMO beam via the signal path 566. Means for performing the operations of block 712 may include the processor 210, 212, 214, 216, 218, 252, 260 and the wireless transceiver 266.

In block 714, the processor may transmit control messages to the RIS to control the RIS to transmit the second subset of packets towards the second wireless device through signal reflection. For example, the processor may control the RIS 506 to reflect the second MIMO beam toward the UE 502 via the signal path 564. Means for performing the operations of block 714 may include the processor 210, 212, 214, 216, 218, 252, 260.

In the operations in blocks 710, 712 and 714 may be performed in a continuous process and/or in a different order. For example, the processor may control the RIS to reflect the second subset of packets towards the second wireless device in block 714 before beginning to transmit the first and second subsets of packets alternatively in blocks 710 and 712. Further, while alternatively transmitting the first subsets of packets via the first MIMO beam and transmitting the second subsets of packets via the second MIMO beam, the processor may periodically send messages to the RIS to adjust the retransmission direction of the second MIMO beam to accommodate movement of the second wireless device.

Referring to the operations 700c illustrated in FIG. 7C, following or in parallel with dividing the message that is to be sent to a second wireless device at a second location into different portions in block 602, the processor may determine signal qualities of wireless signals transmitted over the two or more different spatially separated signal paths in block 720. For example, the processor may determine an SINR, a CQI, or another indication of signal quality for the two or more different spatially separated signal paths. Means for performing the operations of block 720 may include the processor 210, 212, 214, 216, 218, 252, 260.

In block 722, the processor may allocate the different portions of the message for transmitting via the two or more different spatially separated signal paths based on the determined signal qualities of the two or more different spatially separated signal paths. For example, the wireless device may allocate more, or fewer, portions of the message to a spatially separated signal path based on the signal quality of the signal path. In some embodiments, the signal quality of one or more of the spatially separated signal paths may vary over time. In some embodiments, the processor may dynamically adjust the allocation of the different portions of the message to the spatially separated signal paths based on changes in the signal quality or qualities of the signal paths. Means for performing the operations of block 722 may include the processor 210, 212, 214, 216, 218, 252, 260.

The processor may then transmit to the second wireless device at the second location different portions of a message via two or more different spatially separated signal paths in block 604 as described.

Referring to the operations 700d illustrated in FIG. 7D, in some embodiments, in block 730 the processor may map different coded bits of the message resulting from channel coding to different modulation points. In some embodiments, the processor may receive a signal that is output from a channel coding operation, and may divide the signal into portions, such as one or more coded bits, or one or more groups of coded bits. Means for performing the operations of block 730 may include the processor 210, 212, 214, 216, 218, 252, 260 and the wireless transceiver 266.

In block 732, the processor may map the coded bits to different modulation points of a modulation scheme. In some embodiments, the processor may map one or more coded bits, or one or more groups of coded bits, to one of several modulation points of a modulation scheme. In various modulation schemes, coded bits or groups of coded bits of a message may be mapped to different patterns of phase, amplitude and/or frequency (referred to as modulation points) in the transmitted signals that the receiving device can recognize and use to replicate the coded bits. For example, coded bits may be mapped to a modulation scheme by shifting the phase of the transmitted signal in a defined manner. For example, coded bits may be mapped to symbols that are mapped in the difference in phase between successive samples, which is referred to as differential phase-shift keying (DPSK). As another example, four different symbols of coded bits (e.g., 0001, 0010, etc.) may be mapped to four phase patterns, which is referred to as quadrature phase-shift keying (QPSK). As another example, symbols may be mapped to different amplitudes of the transmitted signal, such as quadrature amplitude modulation (QAM). In various embodiments, in addition to mapping bits to the corresponding modulation points, two or more of the different modulation points may be allocated or otherwise processed for transmission by different beams (e.g., MIMO beams).

For example, the processor may select a common modulation constellation (referred to herein as a component constellation) for each beam per modulation symbol. In some embodiments, a size of q coded bits of the component constellation may be represented as 2^{q}. In some embodiments, the processor may determine a constellation aggregation level over time. For example, the processor may aggregate a set of modulation positions across multiple symbols over a number of symbols, which may be represented as t symbols. In some embodiments, a total size of the constellation aggregation may be represented as 2^{(q·t)}.

In some embodiments, the processor may partition the aggregate constellation (e.g., 2^{(q·t)} into a number r of subsets, in which r represents a rank of a channel, and the processor may transmit the same number r of beams during different symbol periods, such as periods of duration t.

In some embodiments, the processor may select or determine a size of each subset based on a channel quality (e.g., proportional to a respective channel quality). In some embodiments, the processor may map qt coded bits of the message to be transmitted to r subsets. In some embodiments, the processor may determine such proportion based on a data rate of each subset (e.g., according to a respective CQI). In some embodiments, the processor may transmit in each beam the constellation points in each respective subset. In some embodiments, the processor may map qt coded bits of the message to r subsets subject to pseudorandom variations over time, in which a pseudorandom sequence may be encrypted using an encryption key that is exchanged (e.g., between the wireless device and a second wireless device) in advance. Means for performing the operations of block 732 may include the processor 210, 212, 214, 216, 218, 252, 260 and the wireless transceiver 266.

In block 734, the processor may transmit the coded bits of the message mapped in the different modulation points via different spatially separated beams (e.g., MIMO beams) in which each of the different beams transmits a corresponding one of the different modulation points. Means for performing the operations of block 734 may include the processor 210, 212, 214, 216, 218, 252, 260 and the wireless transceiver 266.

In some embodiments, the operations in blocks 730-734 may be performed in a single process or operation. For example, the operations of dividing the message into coded bits and mapping the coded bits to different modulation points may be performed in the same process of encoding the message for transmission via different the wireless transceiver 266.

Referring to operations 700e illustrated in FIG. 7E, in some embodiments as part of the operations of mapping the coded bits to different modulation points of a modulation scheme in block 732, the processor may aggregate modulation positions of a component constellation across a plurality of symbols to determine a constellation aggregation in block 740. Means for performing the operations of block 740 may include the processor 210, 212, 214, 216, 218, 252, 260.

In block 742, the processor may partition the constellation aggregation into a plurality of subsets of symbols wherein each subset corresponds to a different beam. Means for performing the operations of block 742 may include the processor 210, 212, 214, 216, 218, 252, 260.

In block 744, the processor may transmit each of the subsets of symbols via a corresponding beam. In some embodiments, the processor may transmit each of the subsets of symbols via holographic MIMO beams corresponding to the subsets of symbols. Means for performing the operations of block 744 may include the processor 210, 212, 214, 216, 218, 252, 260 and the wireless transceiver 266.

FIG. 7F is a conceptual diagram illustrating an example aggregate constellation 700f according to an example modulation scheme useful in some embodiments (e.g., embodiments illustrated in FIGS. 700D and 700E). An example modulation scheme combines QPSK and QAM such that two Quadrature Phase Shift Keying (QPSK) symbols form one 16 Quadradture Amplitude Modulation (16 QAM) aggregate constellation. For example, a component constellation may be QPSK (q=2), channel rank r=2, aggregation level t=2. The aggregate constellation may be effectively 16-QAM. In some embodiments, the processor may partition the 16-QAM constellation into two subsets. In some embodiments, the processor may perform the partitioning based on channel quality. For example, a first subset may include 6 points and a second subset may include 10 points. The processor may allocate the 6 points of the first subset to a first beam (“Beam 1”) and the 10 points of the second subset to a second beam (“Beam 2”). In some embodiments, the processor may determine the partitioning based on the separation in Euclidean distance between constellations of modulation points in the first subset. In some embodiments, the determined partition may be pseudorandom subject to a security key.

FIG. 7G is a conceptual diagram illustrating example index modulation schemes for H-MIMO according to various embodiments. An H-MIMO antennal panel of a wireless device, such as the H-MIMO antennal panel 752 and the H-MIMO antennal panel 754, may be divided into subpanels, such as four subpanels, corresponding to a constellation point of a QPSK constellation 750. In some embodiments, a processor of the wireless device may alternate transmissions from the subpanels to create a “MIMO-like” system (having, for example, q=2, t=1, r=4). In some embodiments, the subpanels may have similar channel qualities, enabling a simple constellation partition. In various embodiments, a signal for each constellation point may be sent along spatially separated signal paths. For example, the H-MIMO antenna panel 752 may transmit signals for different constellation points along spatially separated signal paths 752a, 752b, 752c, and 752d. As another example, the H-MIMO antenna panel 754 may transmit signals for different constellation points along spatially separated signal paths 754a, 754b, 754c, and 754d. In some embodiments, the processor may further randomize a mapping between portions of a message and each constellation point in the modulation scheme. For example, the processor may scramble data bits of the message with a pseudorandom sequence of numbers. As another example, the processor may perform a pseudorandom shuffling of data bits of the message using a pseudorandom sequence of numbers. In this manner, the processor may introduce randomness with the bit-to-constellation point mapping fixed. In some embodiments, a single antenna of the receiving wireless device (e.g., UE 760 or UE 762) may receive a downlink control channel message. Use of a single antenna in some embodiments may enable the wireless device to reduce power consumption, and may reduce complexity and cost of the wireless device.

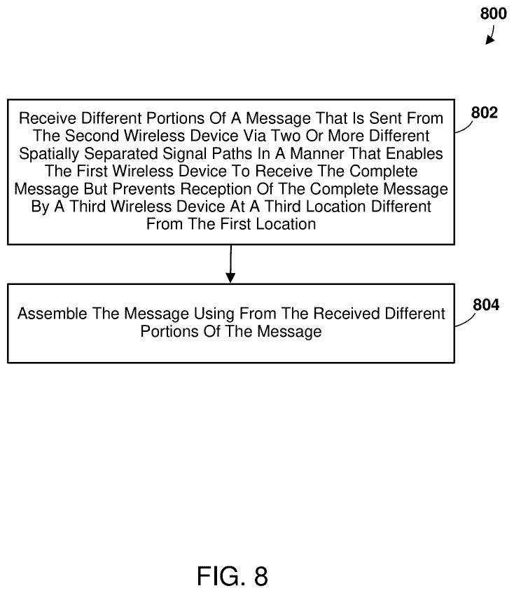

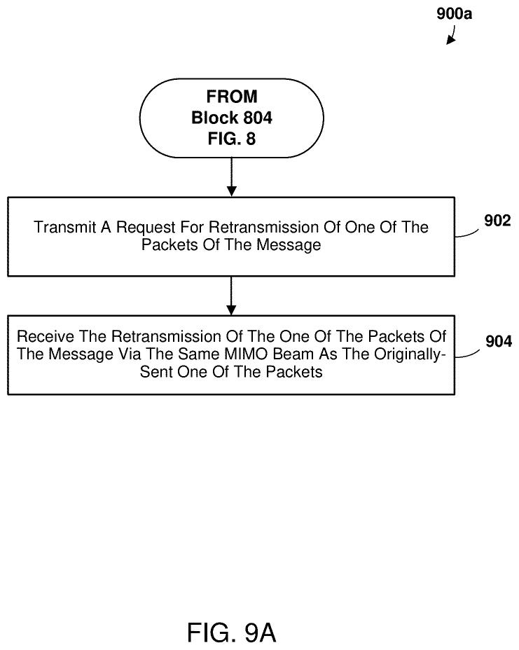

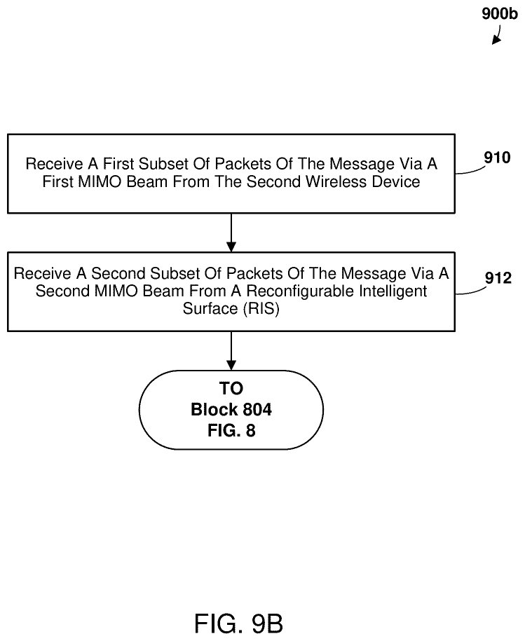

FIG. 8 is a process flow diagram illustrating a method 800 for providing communication security at a physical layer that may be performed by a processor of a wireless device receiving messages (a receiving wireless device) according to various embodiments. With reference to FIGS. 1A-8, the operations of the method 800 may be performed by a processor (e.g., 210, 212, 214, 216, 218, 252, 260) of a receiving wireless device (e.g., 110a, 110a-110d, 120a-120e, 320, 350, 502, 504).

In block 802, the processor may receive different portions of a message sent from a second wireless device (a transmitting wireless device) via two or more different spatially separated signal paths. In some embodiments, the different portions of the message may be sent via the two or more different spatially separated signal paths in a manner that enables the wireless device to receive the complete message but prevents reception of the complete message by a third wireless device at a third location different from the location of the receiving wireless device. In some embodiments, the processor may receive different groups of packets of the message via respective ones of two to more MIMO beams. In some embodiments, the processor may receive coded bits of the message via two or more different beams in which each beam corresponds to different modulation points of a modulation scheme. In some embodiments, the processor may receive subsets of symbols via H-MIMO beams carrying the subsets of symbols. Means for performing the operations of block 802 may include the processor 210, 212, 214, 216, 218, 252, 260 and the wireless transceiver 266.

In block 804, the processor may assemble the message from the received different portions of the message. In some embodiments, the processor may assemble the message from the received different groups of packets of the message using MIMO reception techniques. In some embodiments, the processor may assemble the message from the received different modulation points from the two or more different beams. In some embodiments, the processor may assemble the message from subsets of symbols received in two or more H-MIMO beams. Means for performing the operations of block 804 may include the processor 210, 212, 214, 216, 218, 252, 260.

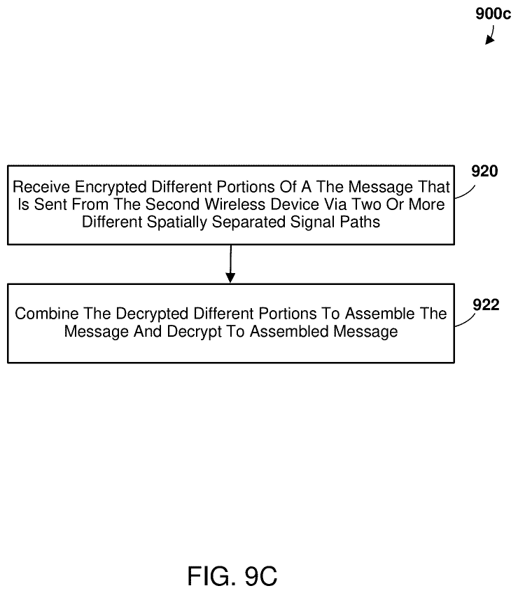

FIGS. 9A-9C are process flow diagrams illustrating operations 900a-900c that may be performed as part of the method 800 for providing communication security at a physical layer that may be performed by a processor of a wireless device according to various embodiments. With reference to FIGS. 1A-9C, the operations 900a-900c may be performed by a processor (e.g., 210, 212, 214, 216, 218, 252, 260) of a wireless device (e.g., 110a, 110a-110d, 120a-120e, 320, 350, 502, 504).

Referring to the operations 900a illustrated in FIG. 9A, in block 902, the processor may transmit a request for retransmission of one or more of the packets of the message. Such a request may be transmitted in response to the processor determining that one or more packets was not successfully received, recognized or decoded. Means for performing the operations of block 902 may include the processor 210, 212, 214, 216, 218, 252, 260 and the wireless transceiver 266.

In block 904, the processor may receive retransmission of the one or more of the packets of the message via the same MIMO beam as the originally-sent one or more of the packets. Means for performing the operations of block 904 may include the processor 210, 212, 214, 216, 218, 252, 260 and the wireless transceiver 266.

Referring to the operations 900b illustrated in FIG. 9B, in block 910, the processor may receive a first subset of packets of the message via a first MIMO beam from the second wireless device. Means for performing the operations of block 910 may include the processor 210, 212, 214, 216, 218, 252, 260 and the wireless transceiver 266.

In block 912, the processor may receive a second subset of packets of the message via a second MIMO beam from a reconfigurable intelligent surface (RIS). The operations in block 910 and 912 may be performed at the same time or approximately simultaneously. Means for performing the operations of block 912 may include the processor 210, 212, 214, 216, 218, 252, 260 and the wireless transceiver 266.

The processor may then assemble the message from the received different portions of the message using MIMO techniques in block 804 of the method 800 as described.

Referring to the operations 900c illustrated in FIG. 9C, in block 920, the processor may receive the different portions of the encrypted message sent from the second wireless device via two or more different spatially separated signal paths. Means for performing the operations of block 920 may include the processor 210, 212, 214, 216, 218, 252, 260 and the wireless transceiver 266.

In block 922, the processor may assemble the message using the received different portions of the message including combining the different portions to assemble the message and decrypting the assembled message. Means for performing the operations of block 922 may include the processor 210, 212, 214, 216, 218, 252, 260 and the wireless transceiver 266.

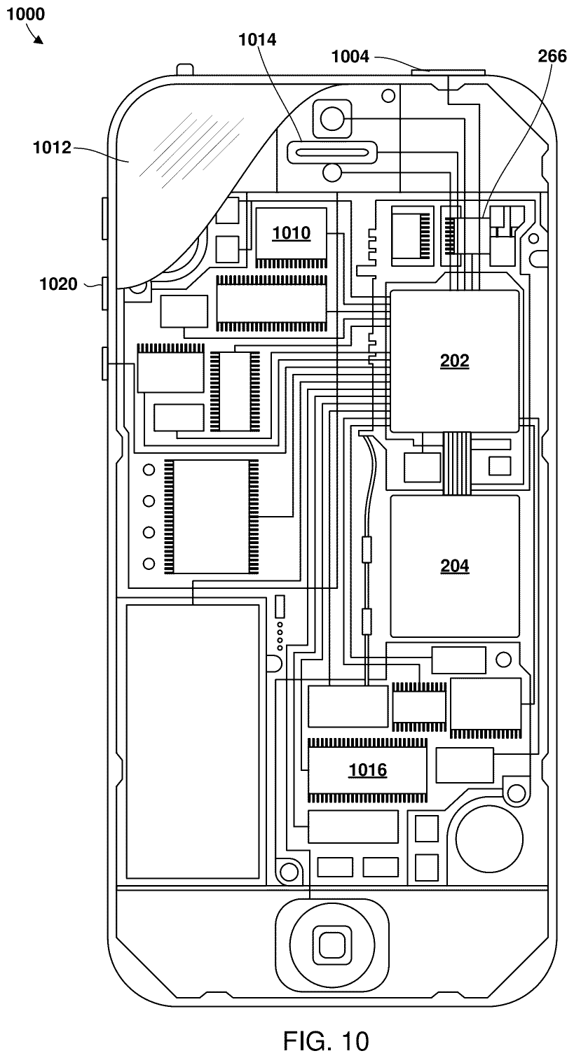

FIG. 10 is a component block diagram of a wireless device 1000 suitable for use with various embodiments. With reference to FIGS. 1A-10, various embodiments may be implemented on a variety of wireless devices (for example, the UEs 120a-120e, 320, 760, 762), an example of which is illustrated in FIG. 10 in the form of a smartphone. The wireless device 1000 may include a first SOC 202 (for example, a SOC-CPU) coupled to a second SOC 204 (for example, a 5G capable SOC). The first and second SOCs 202, 204 may be coupled to internal memory 1016, a display 1012, and to a speaker 1014. Additionally, the wireless device 1000 may include an antenna 1004 for sending and receiving electromagnetic radiation that may be connected to a wireless transceiver 266 coupled to one or more processors in the first and/or second SOCs 202, 204. The wireless device 1000 may include menu selection buttons or rocker switches 1020 for receiving user inputs.

The wireless device 1000 may include a sound encoding/decoding (CODEC) circuit 1010, which digitizes sound received from a microphone into data packets suitable for wireless transmission and decodes received sound data packets to generate analog signals that are provided to the speaker to generate sound. One or more of the processors in the first and second SOCs 202, 204, wireless transceiver 266 and CODEC 1010 may include a digital signal processor (DSP) circuit (not shown separately).

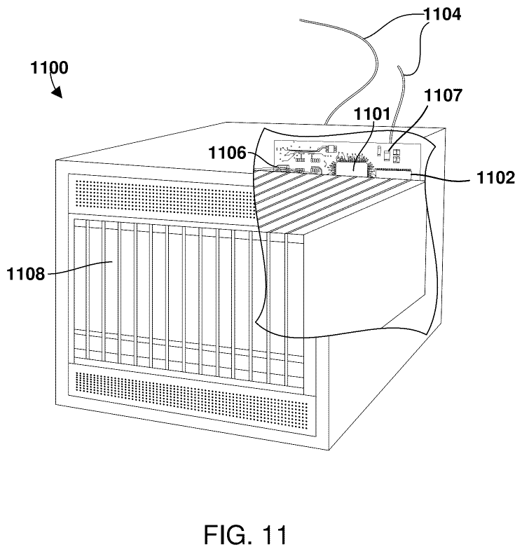

FIG. 11 is a component block diagram of a wireless device 1100 suitable for use with various embodiments. Such wireless devices (e.g., base station 110a-110d, 350, 550) may include at least the components illustrated in FIG. 11. With reference to FIGS. 1A-11, the wireless device 1100 may include a processor 1101 coupled to volatile memory 1102 and a large capacity nonvolatile memory, such as a disk drive 1108. The wireless device 1100 also may include a peripheral memory access device 1106 such as a floppy disc drive, compact disc (CD) or digital video disc (DVD) drive coupled to the processor 1101. The wireless device 1100 also may include network access ports 1104 (or interfaces) coupled to the processor 1101 for establishing data connections with a network, such as the Internet or a local area network coupled to other system computers and servers. The wireless device 1100 may include one or more antennas 1107 for sending and receiving electromagnetic radiation that may be connected to a wireless communication link. The wireless device 1100 may include additional access ports, such as USB, Firewire, Thunderbolt, and the like for coupling to peripherals, external memory, or other devices.

The processors of the wireless devices 1000 and 1100 may be any programmable microprocessor, microcomputer or multiple processor chip or chips that can be configured by software instructions (applications) to perform a variety of functions, including the functions of some implementations described below. In some wireless devices, multiple processors may be provided, such as one processor within an SOC 204 dedicated to wireless communication functions and one processor within an SOC 202 dedicated to running other applications. Software applications may be stored in the memory 1016, 1102 before they are accessed and loaded into the processor. The processors may include internal memory sufficient to store the application software instructions.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, or a computer. By way of illustration, both an application running on a UE and the UE may be referred to as a component. One or more components may reside within a process or thread of execution and a component may be localized on one processor or core or distributed between two or more processors or cores. In addition, these components may execute from various non-transitory computer readable media having various instructions or data structures stored thereon. Components may communicate by way of local or remote processes, function or procedure calls, electronic signals, data packets, memory read/writes, and other known network, computer, processor, or process related communication methodologies.

A number of different cellular and mobile communication services and standards are available or contemplated in the future, all of which may implement and benefit from the various embodiments. Such services and standards include, e.g., third generation partnership project (3GPP), long term evolution (LTE) systems, third generation wireless mobile communication technology (3G), fourth generation wireless mobile communication technology (4G), fifth generation wireless mobile communication technology (5G) as well as later generation 3GPP technology, global system for mobile communications (GSM), universal mobile telecommunications system (UMTS), 3GSM, general packet radio service (GPRS), code division multiple access (CDMA) systems (e.g., cdmaOne, CDMA1020™), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the methods and operations described herein may be substituted for or combined with one or more operations of the methods and operations.

Implementation examples are described in the following paragraphs. While some of the following implementation examples are described in terms of example methods, further example implementations may include: the example methods discussed in the following paragraphs implemented by a wireless device including a processor configured with processor-executable instructions to perform operations of the methods of the following implementation examples; the example methods discussed in the following paragraphs implemented by a wireless device including means for performing functions of the methods of the following implementation examples; and the example methods discussed in the following paragraphs may be implemented as a non-transitory processor-readable storage medium having stored thereon processor-executable instructions configured to cause a processor of a wireless device to perform the operations of the methods of the following implementation examples.

Example 1. A method performed by a first wireless device at a first location for providing communication security at a physical layer in messages sent to a second wireless device at a second location remote from the first location, the method including dividing a message to be sent to the second wireless device into different portions, and transmitting the different portions of the message to the second wireless device via two or more different spatially separated signal paths in a manner that enables the second wireless device to receive the complete message but prevents reception of the complete message by a third wireless device at a third location different from the second location.

Example 2. The method of example 1, in which dividing the message to be sent to the second wireless device into different portions includes dividing the message before channel coding into different groups of packets, and transmitting the different portions of the message to the second wireless device via two or more different spatially separated signal paths includes transmitting the different groups of packets of the message via respective ones of a plurality of multiple input multiple output (MIMO) beams.

Example 3. The method of example 2, further including retransmitting one of the different packets of the message via the same MIMO beam as the originally-sent one of the different packets of the message.

Example 4. The method of example 2, in which transmitting different packets of the message via respective ones of a plurality of MIMO beam includes transmitting a first subset of packets of the message via a first MIMO beam directed toward the second wireless device, transmitting a second subset of packets of the message via a second MIMO beam toward a reconfigurable intelligent surface (RIS), and controlling the RIS to transmit the second subset of packets towards the second wireless device through signal reflection.

Example 5. The method of any of examples 1-4, further including encrypting the message prior to transmitting the different portions of the message via the two or more different spatially separated signal paths.

Example 6. The method of any of examples 1-5, further including determining signal qualities of wireless signals transmitted over the two or more different spatially separated signal paths, and allocating the different portions of the message for transmitting via the two or more different spatially separated signal paths based on the determined signal qualities of the two or more different spatially separated signal paths.

Example 7. The method of any of examples 1-6, in which dividing the message to be sent to the second wireless device into different portions includes dividing the message after channel coding into coded bits of the message, mapping the coded bits to different modulation points of a modulation scheme, and transmitting the different portions of the message to the second wireless device via two or more different spatially separated signal paths includes transmitting the coded bits of the message mapped to different modulation points via different beams in which each of the different beams transmits a corresponding one of the different modulation points.

Example 8. The method of example 7, in which mapping the coded bits to different modulation points of a modulation scheme includes aggregating modulation positions of a component constellation across a plurality of symbols to determine a constellation aggregation, partitioning the constellation aggregation into a plurality of subsets of symbols in which each subset corresponds to a different beam, and in which transmitting coded bits of the message mapped to different modulation points via different beams in which each of the different beams transmits a corresponding one of the different modulation points includes transmitting each of the subsets of symbols via a corresponding beam.

Example 9. The method of example 8, in which transmitting each of the subsets of symbols via a corresponding beam includes transmitting each of the subsets of symbols via holographic multiple input multiple output (H-MIMO) beams corresponding to the subsets of symbols.

Example 10. A method performed by a first wireless device at a first location for receiving messages from a second wireless device at a second location remote from the first location, the method including receiving different portions of a message sent from the second wireless device via two or more different spatially separated signal paths in a manner that enables the first wireless device to receive the complete message but prevents reception of the complete message by a third wireless device at a third location different from the first location, and assembling the message from the received different portions of the message.

Example 11. The method of example 10, in which receiving different portions of the message sent from the second wireless device via two or more different spatially separated signal paths includes receiving different groups of packets of the message via respective ones of two to more MIMO beams.

Example 12. The method of example 10, further including transmitting a request for retransmission of one or more of the packets of the message, and receiving retransmission of the one or more of the packets of the message via the same MIMO beam as the originally-sent one or more of the packets.

Example 13. The method of example 10, in which receiving different portions of the message sent from the second wireless device via two or more different spatially separated signal paths includes receiving a first subset of packets of the message via a first MIMO beam from the second wireless device, and receiving a second subset of packets of the message via a second MIMO beam from a reconfigurable intelligent surface (RIS).

Example 14. The method of any of examples 10-13, in which receiving different portions of the message sent from the second wireless device via two or more different spatially separated signal paths includes receiving different portions of the encrypted message sent from the second wireless device via two or more different spatially separated signal paths, and assembling the message using the received different portions of the message includes combining the different portions to assemble the message and decrypting the assembled message.

Example 15. The method of any of examples 10-14, in which receiving different portions of the message sent from the second wireless device via two or more different spatially separated signal paths includes receiving coded bits of the message via two or more different beams in which each beam corresponds to different modulation points of a modulation scheme.

Example 16. The method of example 15, in which receiving coded bits of the message via two or more different beams in which each beam corresponds to different modulation points of a modulation scheme includes receiving subsets of symbols via holographic multiple input multiple output (H-MIMO) beams carrying the subsets of symbols.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method performed by a first wireless device at a first location for providing communication security at a physical layer in messages sent to a second wireless device at a second location remote from the first location, the method comprising:
dividing a message to be sent to the second wireless device into different portions; and
transmitting the different portions of the message to the second wireless device via two or more different spatially separated signal paths in a manner that enables the second wireless device to receive the complete message but prevents reception of the complete message by a third wireless device at a third location different from the second location.

2. The method of claim 1, wherein:
dividing the message to be sent to the second wireless device into different portions comprises dividing the message before channel coding into different groups of packets; and
transmitting the different portions of the message to the second wireless device via two or more different spatially separated signal paths comprises transmitting the different groups of packets of the message via respective ones of a plurality of multiple input multiple output (MIMO) beams.

3. The method of claim 2, further comprising retransmitting one of the different packets of the message via the same MIMO beam as the originally-sent one of the different packets of the message.

4. The method of claim 2, wherein transmitting different packets of the message via respective ones of a plurality of MIMO beam comprises:
transmitting a first subset of packets of the message via a first MIMO beam directed toward the second wireless device;
transmitting a second subset of packets of the message via a second MIMO beam toward a reconfigurable intelligent surface (RIS); and
controlling the RIS to transmit the second subset of packets towards the second wireless device through signal reflection.

5. The method of claim 1, further comprising encrypting the message prior to transmitting the different portions of the message via the two or more different spatially separated signal paths.

6. The method of claim 1, further comprising:
determining signal qualities of wireless signals transmitted over the two or more different spatially separated signal paths; and
allocating the different portions of the message for transmitting via the two or more different spatially separated signal paths based on the determined signal qualities of the two or more different spatially separated signal paths.

7. The method of claim 1, wherein dividing the message to be sent to the second wireless device into different portions comprises:
dividing the message after a channel coding operation into coded bits of the message; and
mapping the coded bits to different modulation points of a modulation scheme; and
transmitting the different portions of the message to the second wireless device via two or more different spatially separated signal paths comprises transmitting the coded bits of the message mapped to different modulation points via different beams, wherein each of the different beams corresponds to one of the different modulation points.

8. The method of claim 7, wherein mapping the coded bits to different modulation points of a modulation scheme comprises:
aggregating modulation positions of a component constellation across a plurality of symbols to determine a constellation aggregation; and
partitioning the constellation aggregation into a plurality of subsets of symbols wherein each subset corresponds to a different beam; and
wherein transmitting coded bits of the message mapped to different modulation points via different beams in which each of the different beams transmits a corresponding one of the different modulation points comprises transmitting each of the subsets of symbols via a corresponding beam.

9. The method of claim 8, wherein transmitting each of the subsets of symbols via a corresponding beam comprises transmitting each of the subsets of symbols via holographic multiple input multiple output (H-MIMO) beams corresponding to the subsets of symbols.

10. A wireless device, comprising:
a processor configured with processor-executable instructions to:
divide a message to be sent from a first location of the wireless device to a second wireless device at a second location into different portions; and
transmit the different portions of the message to the second wireless device via two or more different spatially separated signal paths in a manner that enables the second wireless device to receive the complete message but prevents reception of the complete message by a third wireless device at a third location different from the second location.

11. The wireless device of claim 10, wherein the processor is further configured with processor-executable instructions to:
divide the message into different portions by dividing the message before channel coding into different groups of packets; and
transmit the different groups of packets of the message to the second wireless device via respective ones of a plurality of multiple input multiple output (MIMO) beams.

12. The wireless device of claim 11, wherein the processor is further configured with processor-executable instructions to retransmit one of the different packets of the message via the same MIMO beam as the originally-sent one of the different packets of the message.

13. The wireless device of claim 11, wherein the processor is further configured with processor-executable instructions to:
transmit a first subset of packets of the message via a first MIMO beam directed toward the second wireless device;
transmit a second subset of packets of the message via a second MIMO beam toward a reconfigurable intelligent surface (RIS); and
control the RIS to transmit the second subset of packets towards the second wireless device through signal reflection.

14. The wireless device of claim 10, wherein the processor is further configured with processor-executable instructions to encrypt the message prior to transmitting the different portions of the message via the two or more different spatially separated signal paths.

15. The wireless device of claim 10, wherein the processor is further configured with processor-executable instructions to:
determine signal qualities of wireless signals transmitted over the two or more different spatially separated signal paths; and
allocate the different portions of the message for transmitting via the two or more different spatially separated signal paths based on the determined signal qualities of the two or more different spatially separated signal paths.

16. The wireless device of claim 10, wherein the processor is further configured with processor-executable instructions to:
divide the message after channel coding into coded bits of the message;
map the coded bits to different modulation points of a modulation scheme; and
transmit the coded bits of the message mapped to different modulation points via different beams, wherein each of the different beams corresponds to one of the different modulation points.

17. The wireless device of claim 16, wherein the processor is further configured with processor-executable instructions to:
aggregate modulation positions of a component constellation across a plurality of symbols to determine a constellation aggregation;
partition the constellation aggregation into a plurality of subsets of symbols wherein each subset corresponds to a different beam; and
transmit each of the subsets of symbols via a corresponding beam.

18. The wireless device of claim 17, wherein the processor is further configured with processor-executable instructions to transmit each of the subsets of symbols via holographic multiple input multiple output (H-MIMO) beams corresponding to the subsets of symbols.

19. A method performed by a first wireless device at a first location for receiving messages from a second wireless device at a second location remote from the first location, the method comprising:
receiving different portions of a message sent from the second wireless device via two or more different spatially separated signal paths in a manner that enables the first wireless device to receive the complete message but prevents reception of the complete message by a third wireless device at a third location different from the first location; and
assembling the message from the received different portions of the message.

20. The method of claim 19, wherein receiving different portions of the message sent from the second wireless device via two or more different spatially separated signal paths comprises receiving different groups of packets of the message via respective ones of two to more multiple input multiple output (MIMO) beams.

21. The method of claim 20, further comprising:
transmitting a request for retransmission of one or more of the packets of the message; and
receiving retransmission of the one or more of the packets of the message via the same MIMO beam as the originally-sent one of the packets.

22. The method of claim 20, wherein receiving different portions of the message sent from the second wireless device via two or more different spatially separated signal paths comprises:
receiving a first subset of packets of the message via a first MIMO beam from the second wireless device; and
receiving a second subset of packets of the message via a second MIMO beam from a reconfigurable intelligent surface (RIS).

23. The method of claim 19, wherein:
receiving different portions of the message sent from the second wireless device via two or more different spatially separated signal paths comprises receiving different portions of the encrypted message sent from the second wireless device via two or more different spatially separated signal paths; and
assembling the message using the received different portions of the message comprises receiving the different portions of the message and combining the different portions to assemble the message and decrypting the assembled message.

24. The method of claim 19, wherein receiving different portions of the message sent from the second wireless device via two or more different spatially separated signal paths comprises receiving coded bits of the message via two or more different beams in which each beam corresponds to different modulation points of a modulation scheme.

25. The method of claim 24, wherein receiving coded bits of the message via two or more different beams in which each beam corresponds to different modulation points of a modulation scheme comprises receiving subsets of symbols via holographic multiple input multiple output (H-MIMO) beams carrying the subsets of symbols.

26. A wireless device, comprising:
a processor configured with processor-executable instructions to:
receive different portions of a message from a second wireless device via two or more different spatially separated signal paths in a manner that enables the wireless device to receive the complete message but prevents reception of the complete message by a third wireless device at a location distant from the wireless device; and
assemble the message from the received different portions of the message.

27. The wireless device of claim 26, wherein the processor is further configured with processor-executable instructions to receive the different portions of the message by receiving different groups of packets of the message via respective ones of two or more multiple input multiple output (MIMO) beams.

28. The wireless device of claim 26, wherein the processor is further configured with processor-executable instructions to:
send a request for retransmission of one or more of the packets of the message; and
receive the retransmission of the one or more of the packets of the message via the same MIMO beam as the originally-sent one or more packets.

29. The wireless device of claim 26, wherein the processor is further configured with processor-executable instructions to:
receive the different portions of the message by receiving different portions of the encrypted message sent from the second wireless device via two or more different spatially separated signal paths; and
assemble the message using the received different portions of the message by combining the different portions to assemble the message and decrypting the assembled message.

30. The wireless device of claim 26, wherein the processor is further configured with processor-executable instructions to receive the different portions of the message by receiving coded bits of the message via two or more different beams by receiving subsets of symbols of coded bits via holographic multiple input multiple output (H-MIMO) beams in which each beam carries symbols mapped to different modulation points of a modulation scheme.
